(19) United States
(12) Patent Application Publication
(10) Pub. No.: US 2006/0148700 A1
(43) Pub. Date: Jul. 6, 2006

(54) Methods and compositions for reducing injury to a transplanted organ

(76) Inventors: Daria Mochly-Rosen, Menlo Park, CA (US); Masashi Tanaka, Saitama-City (JP); Robert C. Robbins, Stanford, CA (US)

Correspondence Address: PERKINS COIE LLP, P.O. BOX 2168, MENLO PARK, CA, 94026, US

(21) Appl. No.: 11/271,285

(22) Filed: Nov. 10, 2005

Related U.S. Application Data
(60) Provisional application No. 60/626,564, filed on Nov. 10, 2004.

(51) Int. Cl. A01N 1/02

(52) U.S. Cl. 514/12; 435/1.1

(57) ABSTRACT

Methods for reducing injury to a transplanted mammalian organ or tissue, including inhibiting the development of graft blood vessel disease, are provided. In one form, a method includes administering compositions that include one or more PKC regulators to an organ or tissue donor and an organ or tissue recipient. Methods for decreasing or otherwise modulating an inflammatory response in a mammal are also provided. In one form, a method includes administering one or more regulators of protein kinase C to a patient in need thereof prior to, during or after an event giving rise to an inflammatory response. Methods for inhibiting, or otherwise modulating, a pro-apoptotic event are also provided. In one form, a method includes administering a therapeutically effective amount of an agonist of ε protein kinase C, and optionally an inhibitor of δ protein kinase C.

This application claims priority to U.S. provisional patent application no. 60/626,564 filed Nov. 10, 2004, which is incorporated herein in its entirety by reference.

### STATEMENT REGARDING FEDERALLY SPONSORED RESEARCH

This invention was made with government support under grant numbers HL69669 and HL52141 awarded by the National Institutes of Health. The Government has certain rights in the invention.

### FIELD OF THE INVENTION

The present invention relates to methods of reducing injury to a transplanted organ or tissue, methods of inhibiting development of graft disease in a blood vessel, methods of decreasing an inflammatory response and methods for inhibiting a pro-apoptotic event.

### BACKGROUND OF THE INVENTION

Despite recent advances in immunosuppressive therapy, and in treatment and diagnosis of post-transplant infection-induced complications and acute rejection, graft coronary artery disease (GCAD) remains the leading cause of death in patients who survive more than one year after cardiac transplantation [Taylor, D. O., et al., J. Heart Lung Transplant 22:616-624 (2003)]. The development of GCAD in heart transplant patients is currently inevitable, and, unlike typical coronary artery disease, there is no effective treatment other than re-transplantation. The pathophysiological processes contributing to the initiation and propagation of GCAD, although not completely understood, are multifactorial and likely involve both alloantigen-independent and alloantigen-dependent mechanisms [Vassalli, G., et al., Eur. Heart J. 24:1180-1188 (2003)]. Ischemia-reperfusion injury is the strongest alloantigen-independent factor for the subsequent development of GCAD in a clinical case-control study [Gaudin, P. G., et al., Am. J. Surg. Pathol. 18:338-346 (1994)]. Wang et al. have shown that ischemia-reperfusion injury alone can promote alloantigen-independent formation of GCAD [Wang, C. Y. et al., Circ. Res. 86:982-988 (2000)].

Ischemia-reperfusion injury generates an inflammatory environment, which includes the production of the injurious chemokines and cytokines such as TNF-α, IL-1β and MCP-1, leading to graft failure [Bergese, S. D. et al., Am. J. Pathol. 147:166-175 (1995)]. In addition, numerous studies have shown that cardiomyocyte apoptosis is an early event in the cardiac ischemia-reperfusion injury [Zhao, Z. Q. et al., Cardiovasc. Res. 45:651-660 (2000)].

There is therefore a need for a method of inhibiting injury to a transplanted organ or tissue, and specifically a method of inhibiting development of graft blood vessel disease. The present invention addresses these needs.

### SUMMARY OF THE INVENTION

It has been discovered that treatment of organ transplant donors and organ transplant recipients with compositions that include one or more regulators of the activity of protein kinase C (PKC) decreases injury to the transplanted organ, including inhibiting the development of graft vessel disease. It has further been determined that treatment of patients with the compositions that include one or more regulators of PKC activity decreases an inflammatory response and that selected inhibitors of δ protein kinase C inhibit a pro-apoptotic event in a mammal. Accordingly, the present invention provides methods of reducing injury to a transplanted mammalian organ or tissue, methods of decreasing, or otherwise modulating, an inflammatory response in a mammal and methods for inhibiting, or otherwise modulating, a pro-apoptotic event in a mammal. In a first aspect of the invention, methods of reducing injury to a transplanted mammalian organ or tissue are provided. In one form, a method includes
a) administering a therapeutically effective amount of a first composition comprising an agonist of ε protein kinase C and optionally an inhibitor of δ protein kinase C to an organ or tissue transplant donor prior to or during removal of an organ or tissue to be transplanted;
b) bathing said organ or tissue to be transplanted in a second composition comprising an agonist of ε protein kinase C and optionally an inhibitor of δ protein kinase C after removing said organ or tissue from said organ or tissue transplant donor; and
c) administering a therapeutically effective amount of a third composition comprising an inhibitor of δ protein kinase C and optionally an agonist of ε protein kinase C to an organ or tissue transplant recipient prior to, during or after implantation of said transplanted organ or tissue.

In a second aspect of the invention, methods for inhibiting development of graft disease in a mammalian blood vessel are provided. In one form, a method includes
a) administering a therapeutically effective amount of a first composition comprising an agonist of ε protein kinase C and optionally an inhibitor of ε protein kinase C to an organ or tissue transplant donor prior to or during removal of an organ or tissue to be transplanted;
b) bathing said organ or tissue to be transplanted in a second composition comprising an agonist of ε protein kinase C and optionally an inhibitor of ε protein kinase C after removing said organ or tissue from said organ or tissue transplant donor; and
c) administering a therapeutically effective amount of a third composition comprising an inhibitor of δ protein kinase C and optionally an agonist of ε protein kinase C to an organ or tissue transplant recipient prior to, during or after implantation of said transplanted organ or tissue.

In a third aspect of the invention, methods of decreasing an inflammatory response in a mammal are provided. In one form, a method includes administering a therapeutically effective amount of an agonist of ε protein kinase C, an inhibitor of δ protein kinase C, or a combination thereof, to a patient in need thereof prior to, during or after an event giving rise to an inflammatory response.

In a fourth aspect of the invention, methods of inhibiting a pro-apoptotic event are provided. In one form, a method includes administering a therapeutically effective amount of an agonist of ε protein kinase C and optionally an inhibitor of δ protein kinase C to a patient in need thereof. In other forms of the invention, a therapeutically effective amount of an agonist of ε protein kinase C, an inhibitor of δ protein kinase C, or a combination thereof, is administered to a patient in need thereof.

It is an object of the invention to provide methods for reducing injury to a transplanted mammalian organ or tissue, including inhibiting the development of graft blood vessel disease in a mammalian blood vessel.

It is a further object of the invention to provide methods for decreasing an inflammatory response in a mammal.

It is yet another object of the invention to provide methods for inhibiting a pro-apoptotic event, including decreasing the activity and/or production of a caspase, and the resulting apoptotic process, in a mammal.

These and other objects and advantages of the present invention will be apparent from the descriptions herein.

### BRIEF DESCRIPTION OF THE FIGURES

FIGS. 1A-E. are scanned images depicting a protocol for treatment of heart transplant donor rats and recipient rats with regulators of PKC as discussed more fully in the materials and methods section of Examples 1-3. A-B, After cardioplegic arrest of the donor heart and ligation of the ascending aorta, 2 mL of εPKC activator (ψεRACK; 1.5 nmol) solution was injected antegradely into the coronary artery system through the ascending aorta; C, Hearts were then procured and submerged in εPKC activator (ψεRACK; 0.5 μM) solution for 10 or 100 minutes at 4° C.; D, shows anastamosis of the donor ascending aorta and pulmonary artery to the infra-renal abdominal aorta and inferior vena cava, respectively; E, Prior to reperfusion of the donor heart, 1 mL of δPKC inhibitor (δV1-1; 30 nmol) solution was injected into the recipient inferior vena cava (IVC). Control animals were treated with normal saline (n=14, for each ischemic times).

FIG. 2A. shows a graph of superoxide production after heart transplant donor rats and recipient rats were treated with regulators of PKC as more fully described in Example 1. Closed columns: Control group (n=6, for each ischemic time), open columns: PKC regulator-treated group (n=6, for each ischemic time). Values obtained from naive hearts of PVG (control, no ischemia) served as a reference (n=4). Mean±Standard Error (SE) values are shown.

FIG. 2B. shows ISOL TUNEL positive cell counts after heart transplant donor rats and recipient rats were treated with regulators of PKC as more fully described in Example 2. Closed columns: Control group (n=6, for each ischemic time), open columns: PKC regulator-treated group (n=6, for each ischemic time). Values obtained from naive hearts of PVG rats (control, no ischemia) served as a reference (n=4). Mean±SE values are shown.

FIGS. 3A-D. depict bar graphs showing the activity of various caspases after heart transplant donors and recipients were treated with regulators of PKC as described in Example 2. A, Caspase-2 activity; B, Caspase-3 activity; C, Caspase-8 activity;. D, Caspase-9 activity. Closed columns: Control group (n=6, for each ischemic time); open columns: PKC regulator-treated group (n=6, for each ischemic time). Values obtained from naive hearts of PVG (control, no ischemia) served as a reference (n=4). Mean±SE values are shown.

FIGS. 4A-D. depict bar graphs showing the amount of various mediators and/or indicators of inflammation after heart transplant donor rats and recipient rats were treated with regulators of PKC as more fully described in Example 2. A, MPO activity; B, TNF-α production; C, IL-1β production; D, MCP-1/CCL2 production. Closed columns: Control group (n=6, for each ischemic time); open columns: PKC regulator-treated group (n=6, for each ischemic time). Values obtained from naive hearts of PVG (control, no ischemia) served as a reference (n=4). Mean+SE values are shown. MPO, myeloperoxidase; TNF-α, Tumor Necrosis Factor α; IL-1β, interleukin 1β; MCP-1/CCL2, monocyte/macrophage chemoattractant protein-1.

FIGS. 5A-D. show scanned images of representative sections of cardiac allografts stained with Elastica Van Gieson for morphometric analysis of graft coronary artery disease (GCAD) as a function of treatment with regulators of PKC as more fully described in Example 3. (a) control group with 30 minutes ischemia; (b) PKC regulator-treated group with 30 minutes ischemia; (c) control group with 120 minutes ischemia; and (d) PKC regulator-treated group with 120 minutes ischemia.

FIGS. 5E-G. show bar graphs of various parameters of GCAD for morphometric assessment of cardiac allografts determined as more fully described in Example 3. Closed columns: Control group (n=8, for each ischemic time); open columns: PKC regulator-treated group (n=6, for each ischemic time). Mean+SE values are shown.

FIGS. 6A-F. depict bar graphs showing activity of various caspases, fas ligand expression, fas expression and ISOL TUNEL positive cell counts as a function of treatment with PKC regulators as more fully described in Example 4. A, ISOL TUNEL positive cell counts; B, Caspase-3 activity; C, Caspase-8 activity; D, Caspase-9 activity; E, Fas ligand expression; F, Fas expression. Values are mean±Standard Deviation (SD). Control=saline-treated control group (n=6). Treated=PKC regulator-treated group (n=6). N.S.=not significant.

FIGS. 7A-G. depict bar graphs showing the quantity of various indicated mediators of inflammation after treatment with PKC regulators as more fully described in Example 4. A, Myeloperoxidase activity; B, TNF-α production; C, IL-1β production; D, MCP-1/CCL2 production; E, ICAM-1 production; F, VCAM-1 production; G, Recipient serum creatine phosphokinase MB (CPK-MB) level. Values are mean±SD. Control=saline-treated control group (n=6). Treated=PKC regulator-treated group (n=6). TNF-α, Tumor Necrosis Factor α; IL-1β, interleukin 1β; MCP-1/CCL2, monocyte/macrophage chemoattractant protein-1; ICAM-1, intracellular adhesion molecule-1; VCAM-1, vascular cell adhesion molecule-1.

FIGS. 8A-F. show bar graphs depicting the quantity of various chemokines, cytokines, interferon gamma, and adhesion molecules after treatment with PKC regulators determined as described in Example 4. A, IFN-Y production; B, MCP-1/CCL2 production; C, IP-10/CXCL10 production; D, MIG/CXCL9 production; E, ICAM-1 production; F, VCAM-1 production. Values are mean+SD. Control=saline-treated control group (n=7). Treated=PKC regulator-treated group (n=7). IFN-γ, interferon-γ; MCP-1/CCL2, monocyte/macrophage chemoattractant protein-1; IP-10/CXCL10, interferon-inducible protein 10; MIG/CXCL9, monokine induced by interferon γ; ICAM-1, intracellular adhesion molecule-1; VCAM-1, vascular cell adhesion molecule-1.

FIG. 9A. depicts a graph of cardiac graft beating score in the study groups as a function of the number of days after transplantation as more fully described in Example 5. Values are mean+SD. Control=saline-treated control group (n=7). Treated=PKC regulator-treated group (n=7). N.S.=not significant.

FIG. 9B. depicts a bar graph of cardiac graft beating scores at 10, 20, and 30 days after transplantation as more fully described in Example 5. Values are mean+SD. Control=saline-treated control group (n=7). Treated=PKC regulator-treated group (n=7). N.S.=not significant.

FIGS. 10A-B. are scanned images showing representative sections of cardiac allografts stained with Elastic Van Gieson for morphometric analysis of GCAD in the saline-treated control group (a) and PKC regulator-treated group (b) as more fully described in Example 5.

FIGS. 10C-E. show bar graphs of various parameters of GCAD at 30 days after transplantation for morphometric assessment of cardiac allografts as more fully described in Example 5. Values are mean+SD. Control=saline-treated control group (n=7). Treated=PKC regulator-treated group (n=7).

### DESCRIPTION OF THE PREFERRED EMBODIMENT

For the purposes of promoting an understanding of the principles of the invention, reference will now be made to preferred embodiments and specific language will be used to describe the same. It will nevertheless be understood that no limitation of the scope of the invention is thereby intended, such alterations and further modifications of the invention, and such further applications of the principles of the invention as illustrated herein, being contemplated as would normally occur to one skilled in the art to which the invention relates.

The present invention provides methods of reducing injury to a transplanted biological structure, such as an organ or tissue. It has been discovered that administration as described herein of a composition that includes one or more regulators of protein kinase C (PKC) reduces injury to a transplanted organ, including reducing the development of disease resulting from such injury, such as graft vessel disease. The injury may arise from, for example, ischemia or an ischemic event arising from the transplantation procedure. “Ischemia” or “ischemic event”, as used herein refers to an insufficient supply of blood to a specific cell, tissue or organ. A consequence of decreased blood supply is an inadequate supply of oxygen (hypoxia) and nutrients to the organ or tissue. The injury includes cell, tissue or organ damage or death that may occur as a result of transplantation of an organ or tissue.

It has also been discovered that administering an agonist of εPKC, an inhibitor of δPKC, or a combination thereof to a patient in need thereof prior to, after or during an event giving rise to an inflammatory response decreases the inflammatory response. Although not being limited by theory, it has been discovered that the inflammatory response may be decreased at least in part by decreasing the activity of various mediators of inflammation, including cytokines, chemokines and adhesion molecules. Accordingly, in yet another aspect of the invention, methods of decreasing an inflammatory response in a mammal are provided.

It has further been discovered that an εPKC agonist, either alone or in combination with an inhibitor of δPKC, may be used to regulate a pro-apoptotic event, including regulating the activity and/or production of a caspase in a mammal. Accordingly, methods of modulating a pro-apoptotic event in a mammal are provided herein.

In one aspect of the invention, methods of reducing injury to a mammalian transplanted organ or tissue are provided. In one form, a method includes
a) administering a therapeutically effective amount of a first composition comprising an agonist of ε protein kinase C and optionally an inhibitor of δ protein kinase C to an organ or tissue transplant donor prior to or during removal an organ or tissue to be transplanted;
b) bathing said organ to be transplanted in a second composition comprising an agonist of ε protein kinase C and optionally an inhibitor of δ protein kinase C after removing said organ or tissue from said organ or tissue transplant donor; and
c) administering a therapeutically effective amount of a third composition comprising an inhibitor of δ protein kinase C and optionally an agonist of ε protein kinase C to an organ or tissue transplant recipient prior to, during or after implantation of said transplanted organ or tissue.

Injury may be reduced in a wide variety of organs that are transplanted. For example, injury may be reduced according to the methods of the present invention when the transplanted organ is a heart, a lung, pancreas, a kidney, a liver, or an intestine, including small and/or large intestines.

Injury may also be reduced to a wide variety of tissues that are transplanted, including, cartilage, muscle flaps, bone, ovarian tissue, cornea, heart valves, veins, arteries, skin and other tissues known in the art that are transplanted.

A wide variety of agonists of εPKC may be utilized in the present invention. By agonist of εPKC, it is meant herein a compound that either activates εPKC, to form activated PKC, facilitates or allows εPKC to perform its biological functions, or mimics the activity of εPKC to allow the mimic to carry out one or more of the biological functions of εPKC. The agonists may, for example, allow for activated εPKC to be translocated to specific areas of the cell so that it may exert its biological effect. As known in the art, εPKC is a serine/threonine kinase and is involved in a myriad of cellular process, including regulation of various physiological functions, such as the activation of various biological systems, including the nervous, endocrine, and exocrine systems. The agonist may be a protein, or other organic or inorganic compound.

Suitable small molecules that may act as an inhibitor of εPKC may be determined by methods known to the art. For example, such molecules may be identified by their ability to translocate εPKC to its subcellular location. Such assays may utilize, for example, fluorescently-labeled enzyme and fluorescent microscopy to determine whether a particular compound or agent may aid in the cellular translocation of εPKC. Such assays are described, for example, in Schechtman, D. et al., J. Biol. Chem. 279(16):15831-15840 (2004) and include use of selected antibodies. Other assays to measure cellular translocation include Western blot analysis as described in Dorn, G. W.,II et al., Proc. Natl. Acad. Sci. U.S.A. 96(22):12798-12803 (1999) and Johnson, J. A. and Mochly-Rosen, D., Circ Res. 76(4):654-63 (1995).

In certain forms of the invention, a protein agonist of εPKC may be utilized. The protein agonist may be in the form of a peptide. Protein, peptide and polypeptide are used interchangeably herein and refer to a compound made up of a chain of amino acid monomers linked by peptide bonds. Unless otherwise stated, the individual sequence of the peptide is given in the order from the amino terminus to the carboxyl terminus. The agonist of εPKC may be obtained by methods known to the skilled artisan. For example, the protein agonist may be chemically synthesized using various solid phase synthetic technologies known to the art and as described in, for example, Williams, Paul Lloyd, et al. Chemical Approaches to the Synthesis of Peptides and Proteins, CRC Press, Boca Raton, Fla., (1997).

Alternatively, the protein agonist may be produced by recombinant technology methods as known in the art and as described, for example, in Sambrook et al., Molecular Cloning: A Laboratory Manual, Cold Springs Harbor laboratory, 2^{nd} ed., Cold Springs Harbor, N.Y. (1989); Martin, Robin, Protein Synthesis: Methods and Protocols, Humana Press, Totowa, N.J. (1998); and Current Protocols in Molecular Biology (Ausubel et al., eds.), John Wiley & Sons, which is regularly and periodically updated. For example, an expression vector may be used to produce the desired peptide agonist in an appropriate host cell and the product may then be isolated by known methods. The expression vector may include, for example, the nucleotide sequence encoding the desired peptide wherein the nucleotide sequence is operably linked to a promoter sequence.

As defined herein, a nucleotide sequence is “operably linked” to another nucleotide sequence when it is placed in a functional relationship with another nucleotide sequence. For example, if a coding sequence is operably linked to a promoter sequence, this generally means that the promoter may promote transcription of the coding sequence. Operably linked means that the DNA sequences being linked are typically contiguous and, where necessary to join two protein coding regions, contiguous and in reading frame. However, since enhancers may function when separated from the promoter by several kilobases and intronic sequences may be of variable length, some nucleotide sequences may be operably linked but not contiguous. Additionally, as defined herein, a nucleotide sequence is intended to refer to a natural or synthetic linear and sequential array of nucleotides and/or nucleosides, and derivatives thereof. The terms “encoding” and “coding” refer to the process by which a nucleotide sequence, through the mechanisms of transcription and translation, provides the information to a cell from which a series of amino acids can be assembled into a specific amino acid sequence to produce a polypeptide.

The agonist may be an εPKC selective agonist peptide. For example, the peptide may be capable of activating signaling proteins, such as PKC, that are activated in vivo by binding to a cognate polypeptide such as a receptor protein (RACK). Regions of homology between the PKC signaling peptide and its RACK are termed “pseudo-RACK” sequences [ψ-RACK; Ron, D., et al., Proc. Natl. Acad. Sci. USA 91:839-843 (1994); Ron, D. and Mochly-Rosen, D., Proc. Natl. Acad. Sci. U.S.A. 92(2):492-496 (1995); Dorn, G. W., et al., Proc. Natl. Acad. Sci. U.S.A. 96(22):12798-12803 (1999); and Souroujon, M. C. and Mochly-Rosen, D., Nature Biotech. 16(10):919-924 (1998)] and typically have a sequence similar to the PKC-binding region of the corresponding RACK. A ψ-RACK sequence that acts as an εPKC specific agonist peptide is identified herein as SEQ ID NO:1 (HDAPIGYD) from Rattus norvegicus, which represents amino acids 85 to 92 as seen in Genbank Accession No. NP_{—}058867. This peptide, referred to herein as ψεRACK, is an εPCK specific agonist peptide and induces translocation of εPKC.

The peptides may include natural amino acids, such as the L-amino acids or non-natural amino acids, such as D-amino acids. The amino acids in the peptide may be linked by peptide bonds or, in modified peptides described herein, by non-peptide bonds.

A wide variety of modifications to the amide bonds which link amino acids may be made and are known in the art. Such modifications are discussed in general reviews, including in Freidinger, R. M. “Design and Synthesis of Novel Bioactive Peptides and Peptidomimetics” J. Med. Chem. 46:5553 (2003), and Ripka, A. S., Rich, D. H. “Peptidomimetic Design” Curr. Opin. Chem. Biol. 2:441 (1998). These modifications are designed to improve the properties of the peptide in one of two ways: (a) increase the potency of the peptide by restricting conformational flexibility; (b) increase the half-life of the peptide by introducing non-degradable moieties to the peptide chain.

Examples of strategy (a) include the placement of additional alkyl groups on the nitrogen or alpha-carbon of the amide bond, such as the peptoid strategy of Zuckerman et al, and the alpha modifications of, for example Goodman, M. et al. [Pure Appl. Chem. 68:1303 (1996)]. The amide nitrogen and alpha carbon may be linked together to provide additional constraint [Scott et al., Org. Letts. 6:1629-1632 (2004)].

Examples of strategy (b) include replacement of the amide bond by, for instance, a urea residue [Patil et al, J. Org. Chem. 68:7274-7280 (2003)] or an aza-peptide link [Zega and Urleb, Acta Chim. Slov. 49:649-662 (2002)]. Other examples such as introducing an additional carbon [“beta peptides”, Gellman, S. H. Acc. Chem. Res. 31:173 (1998)] or ethene unit [Hagihara et al, J. Am. Chem. Soc. 114:6568 (1992)] to the chain, or the use of hydroxyethylene moieties [Patani, G. A., Lavoie, E. J. Chem. Rev. 96:3147-3176 (1996)] are also well known. One or more amino acids may be replaced by an isosteric moiety such as, for example, the pyrrolinones of Hirschmann et al. [J. Am. Chem. Soc. 122:11037 (2000)], or tetrahydropyrans [Kulesza, A. et al., Org. Letts. 5:1163 (2003)].

Although the agonist peptides are described herein with reference to amino acid sequences from Rattus norvegicus it is understood that the peptides are not limited to the specific amino acid sequences set forth in SEQ ID NO:1. Skilled artisans will recognize that, through the process of mutation and/or evolution, polypeptides of different lengths and having different constituents, e.g., with amino acid insertions, substitutions, deletions, and the like, may arise that are related to, or sufficiently similar to, a sequence set forth herein by virtue of amino acid sequence homology and advantageous functionality as described herein. The term “a ψεRACK peptide” is used herein to refer generally to a peptide having the features described herein and a preferred example includes a peptide having the amino acid sequence of SEQ ID NO:1. Also included within these definitions, and in the scope of the invention, are variants of the peptides which function in reducing injury to a transplanted organ or tissue, modulating the activity and/or production of mediators of inflammation as described herein or modulating a pro-apoptotic event, or a combination thereof as described herein.

The peptide agonists described herein also encompass amino acid sequences similar to the amino acid sequences set forth herein that have at least about 50% identity thereto and function in reducing injury to a transplanted organ or tissue, modulating the activity of mediators of inflammation as described herein or modulating a pro-apoptotic event, or a combination thereof. Preferably, the amino acid sequences of the peptide inhibitors encompassed in the invention have at least about 60% identity, further at least about 70% identity, preferably at least about 80% identity, more preferably at least about 90% identity, and further preferably at least about 95% identity to the amino acid sequences, including SEQ ID NO:1, set forth herein.

Percent identity may be determined, for example, by comparing sequence information using the advanced BLAST computer program, including version 2.2.9, available from the National Institutes of Health. The BLAST program is based on the alignment method of Karlin and Altschul. Proc. Natl. Acad. Sci. USA 87:2264-2268 (1990) and as discussed in Altschul, et al., J. Mol. Biol. 215:403410 (1990); Karlin And Altschul, Proc. Natl. Acad. Sci. USA 90:5873-5877 (1993); and Altschul et al., Nucleic Acids Res. 25:3389-3402 (1997). Briefly, the BLAST program defines identity as the number of identical aligned symbols (i.e., nucleotides or amino acids), divided by the total number of symbols in the shorter of the two sequences. The program may be used to determine percent identity over the entire length of the proteins being compared. Default parameters are provided to optimize searches with short query sequences in, for example, blastp with the program. The program also allows use of an SEG filter to mask-off segments of the query sequences as determined by the SEG program of Wootton and Federhen, Computers and Chemistry 17:149-163 (1993).

Accordingly, fragments or derivatives of peptide agonists described herein may also be advantageously utilized that include amino acid sequences having the specified percent identities to SEQ ID NO:1 described herein to reduce injury to a transplanted organ or tissue, to modulate the activity and/or production of mediators of inflammation as described herein, to modulate a pro-apoptotic event, or a combination thereof. For example, fragments or derivatives of ψε-PKC that are effective as agonists of εPKC may also advantageously be utilized in the present invention. Therefore, as used herein, a “ψεRACK peptide” refers to a peptide whose amino acid sequence from Rattus norvegicus is set forth in SEQ ID NO:1 and to derivatives and fragments of this peptide.

Conservative amino acid substitutions may be made in the amino acid sequences described herein to obtain derivatives of the peptides that may advantageously be utilized in the present invention. Conservative amino acid substitutions, as known in the art and as referred to herein, involve substituting amino acids in a protein with amino acids having similar side chains in terms of, for example, structure, size and/or chemical properties. For example, the amino acids within each of the following groups may be interchanged with other amino acids in the same group: amino acids having aliphatic side chains, including glycine, alanine, valine, leucine and isoleucine; amino acids having non-aromatic, hydroxyl-containing side chains, such as serine and threonine; amino acids having acidic side chains, such as aspartic acid and glutamic acid; amino acids having amide side chains, including glutamine and asparagine; basic amino acids, including lysine, arginine and histidine; amino acids having aromatic ring side chains, including phenylalanine, tyrosine and tryptophan; and amino acids having sulfur-containing side chains, including cysteine and methionine. Additionally, amino acids having acidic side chains, such as aspartic acid and glutamic acid, are considered interchangeable herein with amino acids having amide side chains, such as asparagine and glutamine.

The derivatives include amino acid sequences where a given amino acid of one group (such as a non-polar amino acid, an uncharged polar amino acid, a charged polar amino acidic amino acid or a charged polar basic amino acid) is substituted with another amino acid from the same amino acid group. For example, it is know that the uncharged polar amino acid serine may be commonly substituted with the uncharged polar amino acid threonine in a peptide without substantially altering the functionality of the peptide. If one is unsure whether a given substitution will affect the functionality of the peptide, then this may be determined without undue experimentation using synthetic techniques and screening assays known in the art. Exemplary derivatives are provided in SEQ ID NOS:2-14, and include the following sequences: HEADIGYD (SEQ ID NO:2); HDAPIGYE (SEQ ID NO:3); HDAPVGYE (SEQ ID NO:4); HDAPLGYE (SEQ ID NO:5); HDAPIGDY (SEQ ID NO:6); HDAPIGEY (SEQ ID NO:7); ADAPIGYD (SEQ ID NO:8); HDGPIGYD (SEQ ID NO:9); HDAAIGYD (SEQ ID NO:10), and combinations of these modifications.

In one preferred embodiment, the sequence “DAPIG” (SEQ ID NO:14) in SEQ ID NO:1 has no more than two modifications at any residue. One, two, or all three of the residues outside the sequence “DAPIG” can be modified. For example, AEAPVGEY (SEQ ID NO:11) is a derivative of SEQ ID NO:1 where all three residues outside the “DAPIG” (SEQ ID NO:14) sequence and two residues within the “DAPIG” sequence are modified. Other examples include HEAPIGDN (SEQ ID NO:12) and HDGDIGYD (SEQ ID NO:13).

It will also be appreciated that fragments of SEQ ID NO:1 and of the modifications described above may be suitable. An exemplary fragment of SEQ ID NO:1 is DAPIG, (SEQ ID NO:14).

A wide variety of inhibitors of δPKC may be utilized in the present invention. By inhibitor of δPKC, it is meant herein a compound that inhibits the biological activity or function of δPKC. As known in the art, δPKC is involved in a myriad of cellular processes, including regulation of cell growth and gene expression. The inhibitors may, for example, inhibit the enzymatic activity of δPKC. The inhibitors may inhibit the activity of δPKC by, for example, preventing activation of δPKC or may prevent binding of δPKC to its protein substrate. Such an inhibition of enzymatic activity would prevent, for example, phosphorylation of amino acids in proteins. The inhibitor may also prevent binding of δPKC to its receptor for activated kinase (RACK) and subsequent translocation of δPKC to its subcellular location. The inhibitor may be a protein, or other organic or inorganic compound. Small molecules or other compounds that inhibit δPKC may be determined by examining the effect of the compound on δPKC translocation using δPKC translocations assays known in the art and in a similar fashion as described herein for εPKC translocation assays.

In certain forms of the invention, a protein inhibitor of δPKC may be utilized. The protein inhibitor may be in the form of a peptide. The inhibitor of δPKC may be obtained by methods known to the skilled artisan. For example, the protein inhibitor may be chemically synthesized or produced by recombinant technology methods as previously described herein.

The inhibitor may be an isotype of PKC, such as δV1-1, whose amino acid sequence from Rattus norvegicus is set forth in SEQ ID NO:15 (SFNSYELGSL) and represents amino acids 8 to 17 of rat δPKC as seen in Genbank Accession No. AAH76505. Alternatively, the peptide inhibitor may be other fragments of PKC, such as δv1-2 and/or δV1 -5, or some combination of δV1-1, δV1-2 and δV1-5. The amino acid sequences of δV1-2 and δV1-5 from Rattus norvegicus are set forth in SEQ ID NO:16 (ALTTDRGKTLV) and SEQ ID NO:17 (KAEFWLDLQPQAKV) respectively. SEQ ID NO:16 represents amino acids 35 to 45 of rat δPKC as seen in Genbank Accession No. AAH76505 and SEQ ID NO:17 represents amino acids 101 to 114 of rat δPKC as seen in Genbank Accession No. AAH76505. The peptide inhibitor may include other fragments or modifications of δPKC, such as δV5, which sequence is set forth in SEQ ID NO:18 (PFRPKVKSPRPYSNFDQEFLNEKARLSYSDKNLIDSMDQSAFAGFSFVNPKFEHLLED), and which differs from human δV5 in Genbank Accession No. BAA01381 in that the aspartic acid residue at position 11 is substituted with a proline.

Although the inhibitor peptides are described herein with reference to amino acid sequences from Rattus norvegicus, it is understood that the peptides are not limited to the specific amino acid sequences set forth in SEQ ID NOS:15-18. As discussed above, skilled artisans will recognize that, through the process of mutation and/or evolution, polypeptides of different lengths and having different constituents, e.g., with amino acid insertions, substitutions, deletions, and the like, may arise that are related to, or sufficiently similar to, a sequence set forth herein by virtue of amino acid sequence homology and advantageous functionality as described herein. The terms “δV1-1 peptide”, “δV1-2 peptide” “δV1-5 peptide” and “δV5 peptide” refer generally to the peptides having the features described herein and preferred examples include peptides having the amino acid sequence of SEQ ID NO:15, SEQ ID NO:16, SEQ ID NO:17, and SEQ ID NO:18, respectively. Also included within these definitions, and in the scope of the invention, are variants of the peptides which function in reducing injury to a transplanted organ or tissue as described herein.

The peptide inhibitors described herein also encompass amino acid sequences similar to the amino acid sequences set forth herein that have at least about 50% identity thereto and function in reducing injury to a transplanted organ or tissue, modulating the activity and/or production of mediators of inflammation as described herein, modulating a pro-apoptotic event, or a combination thereof. Preferably, the amino acid sequences of the peptide inhibitors encompassed in the invention have at least about 60% identity, further at least about 70% identity, preferably at least about 80% identity, more preferably at least about 90% identity, and further preferably at least about 95% identity to the amino acid sequences, including SEQ ID NOS:15-18, set forth herein.

Accordingly, fragments or derivatives of peptide inhibitors described herein may also be advantageously utilized that include amino acid sequences having the specified percent identities to SEQ ID NOS:15-18 described herein to reduce injury to a transplanted organ or tissue, to modulate the activity and/or production of mediators of inflammation as described herein, to modulate a pro-apoptotic event, or a combination thereof. For example, fragments or derivatives of δV1-1, δV1-2, δV1-5 and δV5 that are effective in inhibiting δPKC may also advantageously be utilized in the present invention.

Modifications to δV1-1 that are expected to result in effective inhibition of δPKC and a concomitant reduction of injury to a transplanted organ or tissue, decrease of the activity and/or production of mediators of inflammation as described herein, inhibition of a pro-apoptotic event, or a combination thereof, include the following changes to SEQ ID NO:15 shown in lower case: tFNSYELGSL (SEQ ID NO:19), aFNSYELGSL (SEQ ID NO:20), SFNSYELGtL (SEQ ID NO:21), including any combination of these three substitutions, such as tFNSYELGtL (SEQ ID NO:22). Other potential modifications include SyNSYELGSL (SEQ ID NO:23), SFNSfELGSL (SEQ ID NO:24), SNSYdLGSL (SEQ ID NO:25), SFNSYELpSL (SEQ ID NO:26).

Other possible modifications that are expected to produce a peptide that functions in the invention include changes of one or two L to I or V, such as SFNSYEiGSv (SEQ ID NO:27), SFNSYEvGSi, (SEQ ID NO:28) SFNSYELGSv (SEQ ID NO:29), SFNSYELGSi (SEQ ID NO:30), SFNSYEiGSL (SEQ ID NO:31), SFNSYEvGSL (SEQ ID NO:32), aFNSYELGSL (SEQ ID NO:33), and any combination of the above-described modifications.

Fragments and modification of fragments of δV1-1 are also contemplated, including: YELGSL (SEQ ID NO:34), YdLGSL (SEQ ID NO:35), fdLGSL (SEQ ID NO:36), YdiGSL (SEQ ID NO:37), iGSL (SEQ ID NO:38), YdvGSL (SEQ ID NO:39), YdLpsL (SEQ ID NO:40), YdLgiL (SEQ ID NO:41), YdLGSi (SEQ ID NO:42), YdLGSv (SEQ ID NO:43), LGSL (SEQ ID NO:44), iGSL (SEQ ID NO:45), vGSL (SEQ ID NO:46), LpSL (SEQ ID NO:47), LGiL (SEQ ID NO:48), LGSi (SEQ ID NO:49), LGSv (SEQ ID NO:50).

Accordingly, the term “a δV1-1 peptide” as used herein further refers to a peptide identified by SEQ ID NO:15 and to a peptide having an amino acid sequence having the specified percent identity described herein to the amino acid sequence of SEQ ID NO:15, including but not limited to the peptides set forth in SEQ ID NOS:19-33, as well as fragments of any of these peptides that retain activity for inhibiting injury to a transplanted organ or tissue, decreasing the activity and/or production of mediators of inflammation as described herein, inhibiting a pro-apoptotic event, or a combination thereof, as exemplified by but not limited to SEQ ID NOS:34-50.

Modifications to δV1-2 that are expected to result in effective inhibition of δPKC and a concomitant reduction in injury to a transplanted organ or tissue, decrease in the activity and/or production of mediators of inflammation as described herein, inhibition of a pro-apoptotic event, or a combination thereof, include the following changes to SEQ ID NO:16 shown in lower case: ALsTDRGKTLV (SEQ ID NO:51), ALTsDRGKTLV (SEQ ID NO:52), ALTTDRGKsLV (SEQ ID NO:53), and any combination of these three substitutions, ALTTDRpKTLV (SEQ ID NO:54), ALTTDRGrTLV (SEQ ID NO:55), ALTTDkGKTLV (SEQ ID NO:56), ALTTDkGkTLV (SEQ ID NO:57), changes of one or two L to I, or V and changes of V to I, or L and any combination of the above. In particular, L and V can be substituted with V, L, I R and D, E can be substituted with N or Q.

Accordingly, the term “a δV1-2 peptide” as further used herein refers to a peptide identified by SEQ ID NO:16 and to a peptide having an amino acid sequence having the specified percent identity described herein to the amino acid sequence of SEQ ID NO:16, including but not limited to the peptides set forth in SEQ ID NOS:51-57, as well as fragments of any of these peptides that retain activity for inhibiting injury to a transplanted organ or tissue, decreasing the activity or production of various mediators of inflammation or inhibiting a pro-apoptotic event, or a combination thereof.

Modifications to δV1-5 and δV5 that are expected to result in effective inhibition of δPKC and a concomitant reduction of injury to a transplanted organ or tissue, decrease in the activity and/or production of mediators of inflammation as described herein, inhibition of a pro-apoptotic event, or a combination thereof include modifications similar to the modifications described for δV1-2. The term “a δV1-5 peptide” as further used herein refers to SEQ ID NO:17 and to a peptide having an amino acid sequence having the specified percent identity described herein to an amino acid sequence of SEQ ID NO:17, as well as fragments thereof that retain activity for reducing injury to a transplanted organ or tissue, decreasing the activity or production of various mediators of inflammation or inhibiting a pro-apoptotic event, or a combination thereof. The term “a δV5 peptide” as further used herein refers to SEQ ID NO:18 and to a peptide having an amino acid sequence having the specified percent identity described herein to an amino acid sequence of SEQ ID NO:18, as well as fragments thereof that retain activity for reducing injury to a transplanted organ or tissue, decreasing the activity or production of various mediators of inflammation or inhibiting a pro-apoptotic event, or a combination thereof. The inhibitors used for treatment herein may include a combination of the peptides described herein.

The agonist and/or inhibitor peptides described herein may be modified by being part of a fusion protein. The fusion protein may include a protein or peptide that functions to increase the cellular uptake of the peptide inhibitors or agonists, has another desired biological effect, such as a therapeutic effect, or may have both of these functions. For example, it may be desirable to conjugate, or otherwise attach, the δV1-1 peptide, a ψεRACK peptide or other peptides described herein, to a cytokine or other peptide that elicits a desired biological response. The fusion protein may be produced by methods known to the skilled artisan. The agonist or inhibitor peptide may be bound, or otherwise conjugated, to another peptide in a variety of ways known to the art. For example, the agonist or inhibitor peptide may be bound to a carrier peptide or other peptide described herein by cross-linking wherein both peptides of the fusion protein retain their activity. As a further example, the agonist or inhibitor peptides may be linked or otherwise conjugated to each other by an amide bond from the C-terminal of one peptide to the N-terminal of the other peptide. The linkage between the transmembrane carrier or therapeutic peptide may be non-cleavable, with a peptide bond, or cleavable with, for example, an ester or other cleavable bond.

Furthermore, in other forms of the invention, the carrier protein or peptide that may increase cellular uptake of the peptide agonist or inhibitor may be, for example, a Drosophila melanogaster Antennapedia homeodomain-derived sequence (unmodified sequence may be found in Genbank Accession No. AAD19795) which is set forth in SEQ ID NO:58 (RQIKIWFQNRRMKWKK), and may be attached to the agonist or inhibitor by cross-linking via an N-terminal Cys-Cys bond as discussed in Theodore, L., et al. J. Neurosci. 15:7158-7167 (1995); Johnson, J. A., et al. Circ. Res 79:1086 (1996). The sequence may also be sought from Drosophila hydei and Drosophila virilis. Alternatively, the agonist or inhibitor may be modified by a Transactivating Regulatory Protein (Tat)-derived transport polypeptide (such as from amino acids 47-57 of Tat shown in SEQ ID NO:59; YGRKKRRQRRR) from the Human Immunodeficiency Virus, Type 1, as described in Vives, et al., J. Biol. Chem, 272:16010-16017 (1997), U.S. Pat. No. 5,804,604; and as seen in Genbank Accession No. AAT48070, or with polyarginine as described in Mitchell, et al. J. Peptide Res. 56:318-325 (2000) and Rolhbard, et al., Nature Med. 6:1253-1257 (2000). The agonists and/or inhibitors may be modified by other methods known to the skilled artisan in order to increase the cellular uptake of the inhibitors.

The compositions of the invention may be advantageously administered to the organ or tissue transplant donor or the organ or tissue transplant recipient in various forms. For example, the compositions may be administered in tablet form for sublingual administration, in a solution or emulsion. The compositions may also be mixed with a pharmaceutically-acceptable carrier or other vehicle. The carrier may be a liquid, suitable, for example, for parenteral administration, including water, saline or other aqueous solution, or may be an oil. The carrier may specifically be selected for intravenous or intraarterial administration, and may include a sterile aqueous or non-aqueous solution that may include preservatives, bacteriostats, buffers and antioxidants known to the art. The carrier may be a cardioplegic solution, including amino acid solutions or blood cardioplegia that may contain monosodium glutamate (MSG), monosodium aspartate (MSA), citrate-phosphate-dextrose (CPD) and dextrose. The carrier also includes crystallized solutions that do not contain MSA or MSG. The enrichment of cardioplegic solutions (blood cardioplegia) with amino acids (such as aspartic acid, glutamic acid or salts thereof) has been shown to increase anaerobic production of high-energy phosphates (including adenosine triphosphate) and therefore improves post-ischemic recovery. The carrier solutions, when used to deliver the agents described herein, may be at room temperature (e.g., about 20° C.), above room temperature (e.g., about 37° C.) or may be below room temperature (e.g., about 4° C. to about 7° C.).

In tablet form, a solid carrier may include, for example, lactose, starch, carboxymethyl cellulose, dextrin, calcium phosphate, calcium carbonate, synthetic or natural calcium allocate, magnesium oxide, dry aluminum hydroxide, magnesium stearate, sodium bicarbonate, dry yeast or a combination thereof. The tablet preferably includes one or more agents which aid in oral dissolution. The compositions may also be administered in forms in which other similar drugs known in the art are administered.

As mentioned above, the composition that is administered to the organ or tissue transplant donor includes an agonist of εPKC and optionally an inhibitor of δPKC. Therefore, in certain forms of the invention, the composition may include an agonist of εPKC without an inhibitor of δPKC. In yet other forms of the invention, the composition includes both an agonist of εPKC and an inhibitor of δPKC, both as previously described herein.

As further mentioned above, the composition that is administered to the organ or tissue transplant recipient includes an inhibitor of δPKC and optionally an agonist of εPKC. Therefore, in certain forms of the invention, the composition may include an inhibitor of 8PKC without an agonist of εPKC. In yet other forms of the invention, a composition that includes both an agonist of εPKC and an inhibitor of δPKC is administered to the organ or tissue transplant recipient.

A therapeutically effective amount of the compositions described herein is administered to the patient and/or to the organ or tissue being transplanted. As used herein, a therapeutically effective amount of the composition is the quantity of the composition required to reduce the cell, tissue or organ damage or death that occurs due to transplantation of an organ, especially due to the ischemic event that occurs during transplantation, or that which is required to reduce the cell or tissue damage or death that occurs due to transplantation of a tissue. This amount will vary depending on the length of the transplantation procedure, the time point for administration of the compositions, the route of administration, the duration of treatment, the specific inhibitors and agonists used in the composition, and the health of the patient as known in the art. The skilled artisan will be able to determine the optimum dosage. The therapeutically effective amount of the composition includes an amount required to decrease an inflammatory response in a vertebrate, such as a mammal, as well as the amount required to inhibit a pro-apoptotic event in a vertebrate.

Generally, the amount of the composition administered will be sufficient to deliver an amount of inhibitor equal to, for example, about 0.001 mg/kg body weight to about 100 mg/kg body weight, but will preferably deliver about 0.1 mg/kg body weight to about 10 mg/kg body weight. When the composition includes an εPKC agonist, the amount of the composition administered will be sufficient to deliver an amount of agonist equal to, for example, about 0.01 mg/kg body weight to about 1000 mg/kg body weight, preferably about 3 mg/kg body weight to about 300 mg/kg body weight when administered to either the organ or tissue transplant donor or organ or tissue transplant recipient.

The amount of inhibitor in the compositions will range from about 1 weight percent to about 99 weight percent, and preferably about 20 weight percent to about 70 weight percent. The amount of agonist in the compositions will range from about 1 weight percent to about 99 weight percent, and preferably about 20 weight percent to about 70 weight percent. Weight percent as defined herein is the amount of the agent in mg divided by the 100 grams of the composition.

As mentioned above, the therapeutically effective amount of the composition is administered to an organ or tissue transplant donor. The composition is typically administered prior to removing the organ or tissue to be transplanted. It is also understood that the composition may also be administered during removal of the organ or tissue to be transplanted. In certain forms of the invention where the transplanted organ is a heart, the composition is administered to the donor after the heart has been arrested. The heart is typically arrested by cardioplegic arrest by infusion of ice-cold high potassium cardioplegia solution into the arterial system, such as in the aortic root.

The compositions may be administered to the donor by a wide variety of routes, including parenterally, and preferably intravenously or intraarterially. As one example, when the transplanted organ is a heart, the compositions described herein are administered by an intraarterial route, such as via the coronary artery. In situations where the donor is still alive, such as where a lung, kidney, or portion of intestine or liver of a live donor is transplanted, the compositions may be administered intraperitoneally, intramuscularly, intravenously, rectally, intravaginally, intranasally, sublingually, or transdermally. Preferred modes of delivery of the composition in these cases also include intraarterially or intravenously.

After administering the therapeutically effective amount of the composition to the organ or tissue transplant donor, the organ or tissue is removed by methods well-known to the skilled artisan. Such methods can be found, for example, in Rebecca A. Schroeder, et al. “Clinical Management of the Transplant Patient”, Arnold Publishers, (2001 ); Kremer, B., “Atlas of Liver, Pancreas and Kidney Transplantation”, Georg Thieme Verlag (1994); and Serafin, D., “Atlas of Microsurgical Composite Tissue Transplantation”, W. B. Saunders, (1996).

After the organ or tissue is removed from the organ or tissue transplant donor, it is placed in a container for preservation and/or transport. The organ or tissue is bathed in the container solution, which includes a therapeutically effective amount of an agonist of εPKC and optionally an inhibitor of δPKC as previously described herein. Therefore, in certain forms of the invention both the agonist of εPKC and the inhibitor of δPKC are present in the composition. In other forms of the invention, the agonist of εPKC is present in the composition without the inhibitor of δPKC. The organ or tissue is bathed in the solution for a time period sufficient to reduce the cell, tissue or organ damage or death that occurs due to transplantation of an organ, especially due to the ischemic event that occurs during transplantation, or sufficient to reduce the cell or tissue damage or death that occurs due to transplantation of tissue, and the inflammation and other responses that are associated with the transplantation procedure. Although this time period may vary, the organ or tissue is typically bathed in the composition for about 5 minutes to about 48 hours, preferably about 1 hour to about 8 hours.

The amount of the composition delivered to the bathing solution is also a therapeutically effective amount as described above. The amount of the composition delivered is sufficient to deliver an amount of the agonist to the bathing solution equal to, for example about 0.01 mg/L bathing solution to about 1000 mg/L bathing solution, preferably about 0.1 mg/L t about 10 mg/L bathing solution. In certain forms of the invention, the amount of the composition delivered may also be sufficient to deliver an amount of the inhibitor to the bathing solution equal to, for example, about 0.01 mg/L bathing solution to about 10000 mg/L bathing solution, preferably about 0.1 mg/L to about 10 mg/L bathing solution. Additionally, the compositions used to prepare the bathing solution may include the same weight percentages of the agonist and/or inhibitor described above.

The bathing solution may further include a wide variety of organ or tissue preservation solutions, including University of Wisconsin solution (UW), Plegisol, Physiosol, Euro-Collins (ECS) and UCLA formula organ preservation solutions.

After the organ or tissue is bathed in the compositions described herein, it is implanted by known methods into an organ or tissue transplant recipient. Such methods may be found in, for example, Rebecca A. Schroeder, et al. “Clinical Management of the Transplant Patient”, Arnold Publishers, (2001 ); Kremer, B., “Atlas of Liver, Pancreas and Kidney Transplantation”, Georg Thieme Verlag (1994); and Serafin, D., “Atlas of Microsurgical Composite Tissue Transplantation”, W. B. Saunders, (1996).

A therapeutically effective amount of a composition that includes an inhibitor of δPKC and optionally an agonist of εPKC is administered to an organ or tissue transplant recipient, typically prior to implantation of the organ or tissue. The composition may also be administered to the organ or tissue transplant recipient after or during implantation of the organ or tissue to be transplanted, and including during or after reperfusion of the organ or tissue.

The compositions described herein may be administered to the organ or tissue transplant recipient by a variety of routes, including intraperitoneally, intramuscularly, intravenously, rectally, intravaginally, intranasally, sublingually, or transdermally. Preferred modes of delivery of the composition to the organ transplant recipient include intraarterially or intravenously.

The organ or tissue transplant donor and organ or tissue transplant recipient typically are from the same species. However, organs or tissues from an organ or tissue transplant donor of one species that will function in an organ or tissue transplant recipient of a different species without serious complications may also be transplanted according to the invention. By “serious complications” it is meant herein adverse consequences from having the implanted transplanted organ or tissue that may not be mitigated by treatment. Typical complications that may be mitigated by treatment include immune system rejection of the transplanted organ or tissue. The method is advantageously applied to vertebrates, and preferably to mammals, including humans that are undergoing an organ or tissue transplantation procedure. Other animals which may be treated include farm animals, such as horse, sheep, cattle, and pigs. Other exemplary animals that may be treated include cats, dogs; rodents, including those from the order Rodentia, such as mice, rats, gerbils, hamsters, and guinea pigs; those from the order Lagomorpha, including rabbits and hares, and any other mammal that may benefit from such treatment.

The methods of reducing injury to a transplanted organ or tissue may advantageously be used to inhibit the development of graft blood vessel disease, such as graft artery disease, in an artery or vein. Such a disease arises when blood vessels of an organ are subjected to a prolonged ischemic event. For example, after a heart transplantation procedure, graft coronary artery disease may develop. Accordingly, methods of inhibiting development of graft disease in a blood vessel are provided. In one form, a method of inhibiting development of graft disease in a blood vessel is identical to that described herein for reducing injury to a transplanted organ or tissue.

Development of graft disease from an organ or tissue transplantation procedure may be inhibited from developing in a wide variety of blood vessels, including arteries, veins, as well as vessels of the microvasculature, including arterioles, capillaries and venules. Included within the variety of blood vessels that are affected include those present in the organs that may be transplanted, such as kidney, liver, heart, pancreas, heart, and intestine. Although any vessel of, or connected to, these vessels may be subjected to graft disease, examples of vessels that are affected in the kidney include the renal arteries and renal veins; in the heart include the coronary arteries, the pulmonary arteries, the aorta, the superior and inferior pulmonary veins, the great cardiac vein, the small cardiac vein, the inferior vena cava, and the superior vena cava; in the pancreas include the anterior and posterior inferior pancreaticoduodenal arteries, anterior and posterior superior pancreaticoduodenal arteries, and the pancreatic veins; in the duodenum of the small intestine include the superior and inferior pancreaticoduodenal arteries and the portal vein; in the jejunum and ileum of the small intestine include the superior mesenteric artery and superior mesenteric vein; in the large intestine include the ileocolic artery, the appendicular artery; the right, middle and left colic arteries; the superior sigmoid artery, the sigmoid artery, the ileocolic vein, the right colic vein, and the superior and inferior mesenteric veins. Other affected vessels include the microvasculature of the organs or tissue described herein. It is understood that this list is not an exhaustive list of the blood vessels which may be affected by graft disease and thus is merely illustrative. One skilled in the art is aware of all other vessels in or connected to transplanted organs or tissue that may be affected by graft vessel disease. As an example, included in the arteries that may be affected herein are the arteries from which the aforementioned arteries branch, or are otherwise derived from, and the arteries and branches that the aforementioned arteries drain into or are otherwise connected to. Included in the veins that may be affected herein are the veins from which the aforementioned veins branch, or are otherwise derived from, and the veins and branches that the aforementioned veins drain into or are otherwise connected to.

In yet another aspect of the invention, methods of decreasing an inflammatory response in a vertebrate are provided. In one form, a method includes administering a therapeutically effective amount of a composition that includes an agonist of εPKC and optionally an inhibitor of δPKC to a patient in need thereof prior to, after or during an event giving rise to an inflammatory response.

The agonists of εPKC and inhibitors of δPKC used are identical to that previously described herein. Additionally, the therapeutic amounts are identical to that previously described herein.

A wide variety of events may give rise to an inflammatory response. The events that may give rise to an inflammatory response are typically events which cause the production of, or increased activity of, various chemokines, cytokines and adhesion molecules described herein. Exemplary events that may give rise to inflammation include an ischemic event, the reperfusion event, the lack of histocompatibility, an event that causes autoimmune disease, exposure to allergens, injury of tissues by bacteria, trauma, toxins, heat, or any similar cause.

The inflammatory response is typically decreased by decreasing or otherwise reducing the activity and/or production of one or more mediators of inflammation, including chemokines, cytokines, and adhesion molecules. By decreasing the activity of a cytokine or chemokine, it is meant herein that interaction between the cytokine or chemokine and its respective receptor is decreased, and/or the ability of the cytokine or chemokine to otherwise exert its biological effect is decreased. By decreasing the activity of an adhesion molecule, it is meant herein that the ability of the adhesion molecules to bind cells is decreased, and/or the ability of the adhesion molecules to perform or exert their biological function is decreased. By decreasing the production of a cytokine, chemokine, or adhesion molecule, it is meant herein that the amount of the cytokine, chemokine or adhesion molecule is decreased through any one of a number of mechanisms, including decreasing transcription of the gene(s) encoding the particular cytokine, chemokine or adhesion molecule, or decreasing expression of the ribonucleic acid transcript encoding the cytokine, chemokine or adhesion molecule.

As known in the art, cytokines are proteins that have a variety of biological activities, including primarily regulatory activities. For example, cytokines are involved in the development of the cellular immune response, the development of the humoral immune response, induction of the inflammatory response, regulation of hematopoiesis, control of cellular proliferation, control of cellular differentiation and induction of wound healing. Cytokines exert their effect by binding to receptors on the membranes of target cells. Upon binding, the cytokines trigger signal transduction pathways that affect gene expression in the target cell. Examples of cytokines whose activity or production may be decreased according to the methods of the present invention include tumor necrosis factor-α (TNF-α ), interleukin-1β (IL-1β), interferon γ, or a combination thereof.

Chemokines are a family of cytokines with potent leukocyte activation and/or chemotactic activity. Chemokines are also involved in a wide variety of other biological processes, including control of viral infection and replication, angiogenesis, wound healing, tumor growth, metastasis, homeostasis, and hematopoiesis. They typically enhance inflammation by inducing chemotaxis and cell activation of different types of inflammatory cells typically present at inflammatory sites. Examples of chemokines whose activity or production may be decreased according to the methods of the present invention include monocyte chemoattractant protein-1 (MCP-1/CCL2), interferon-inducible protein 10 (IP-10/CXCL10), monokine induced by interferon γ (MIG/CXCL9), or some combination thereof.

Adhesion molecules are cell surface proteins involved in cell-binding. They typically mediate binding of cells to each other, to endothelial cells or to the extracellular matrix. For example, the Ig superfamily of adhesion molecules function in binding to integrins on leukocytes. In doing so, the adhesion molecules in this family cause flattening of the leukocytes onto the blood vessel wall so they may undergo extravasation into the surrounding tissue. Examples of adhesion molecules whose production may be decreased include those in the Ig superfamily of adhesion molecules, such as intracellular adhesion molecule-1 (ICAM-1) and vascular cell adhesion molecule-1 (V-CAM-1); as well as those in the selectin family of adhesion molecules, such as the cell surface glycoprotein E-selectin.

The patient that is treated is one that is in need of such treatment. The patient may have, for example, a bacterial disease, an autoimmune disease, inflammatory bowel disease, allergies, asthma, or other similar disease or condition giving rising to an inflammatory response in the patient, or may be experiencing some event that gives rise to an inflammatory response. Preferred patients are vertebrates. Patients that may be treated further include mammals, such as humans. Other animals that may be treated include those previously described herein.

In a further aspect of the invention, methods of modulating a pro-apoptotic event are provided. In one form, a method of inhibiting a pro-apoptotic includes administering to a patient in need thereof, such as a mammal and typically a human, a therapeutically effective amount of a composition including an agonist of εPKC and optionally an inhibitor of δ protein kinase C. In yet other forms of the invention, the patient may be treated with only the inhibitor of δ protein kinase C.

The agonists of εPKC and inhibitors of δPKC used are identical to that previously described herein. Additionally, the therapeutic amounts are identical to that previously described herein.

A wide variety of pro-apoptotic events may be inhibited. The events include inactivation and/or decreased production of pro-apoptotic proteins and/or agents which activate or increase production of such proteins. Exemplary pro-apoptotic events that may be inhibited according to the methods of the present invention include DNA laddering, or fragmentation; inhibition of poly(ADP-ribose)polymerase (PARP) cleavage and subsequent inactivation; activation and/or production of caspases, production of reactive oxygen species, such as superoxide production; c-Jun N-terminal kinase activation, release of cytochrome C from the mitochondria into the cytosol; p53 activation, activation of apoptotis-inducing factor, inhibition of the activation and/or production of the pro-apoptotic proteins, such as the pro-apoptotic members of the Bcl-2 family of proteins and including Bcl-Xs, Box-S, Bcl-Rambo/MIL1, Bfk, NIP3/BNIP3, Hrk/DP5, and Bid; and increased activation and/or production of anti-apoptotic proteins, such as the anti-apoptotic members of the Bcl-2 family of proteins, including BaxΩ, BaxΣ. Bcl-w, BclXL, Buffy and Balf1. As this list is only exemplary, other pro-apoptotic events known to the skilled artisan may also be inhibited according to the methods described herein.

In certain forms of the invention, the method includes decreasing the activity and/or production of caspases. Caspases are a family of cysteine proteases that cleave proteins after aspartic acid residues. Caspases are primarily involved in apoptosis. Activation of caspses leads to characteristic morphological changes of the cell. Accordingly, by decreasing the activity of a caspase, it is meant herein that the protease activity of the caspase is reduced, and/or the effect of the caspase on the cell is reduced, such as by decreasing the extent of the morphological changes in the cell that occur during apoptosis and/or decreasing the extent of apoptosis. By decreasing the production of a caspase, it is meant herein that the amount of the caspase is decreased through any one of a number of mechanisms, including decreasing transcription of the genes(s) encoding the particular caspase or decreasing expression of the ribonucleic acid transcript encoding the caspase. The decrease in expression of the ribonucleic acid may be brought about in a number of ways, including by decreasing the activity or production of transcriptional regulators of the particular caspase gene.

The method may be utilized to decrease the activity and/or production of a caspase in situations that exhibit increased activation of caspase. For example, the method may be useful in treating patients that have amyotrophic lateral sclerosis, Alzheimer's disease, Huntington's disease, diabetes, Parkinson's disease, multiple sclerosis, Duchenne muscular dystrophy, and other diseases or conditions that exhibit, or are otherwise associated with, increased caspase activation, including aging.

The activity of a wide variety of caspases and other pro-apoptotic proteins may be regulated according to the methods of the present invention. For example, caspases whose activity and/or production may be decreased include the initiator caspases, such as caspase-2, caspase-8, caspase-9 and caspase-10; the effector caspases, including caspase-3, caspase-6 and caspase-7; as well as caspases that process proinflammatory cytokines, including caspase-1, caspase-4, caspase-5, caspase-11, caspase-12, caspase-13 and caspase-14. Preferred caspases whose activity may be decreased include, for example, caspase-2, caspase-3, caspase-8, caspase-9, and combinations thereof.

Reference will now be made to specific examples illustrating the invention described above. It is to be understood that the examples are provided to illustrate preferred embodiments and that no limitation to the scope of the invention is intended thereby. Additionally, all documents cited herein are indicative of the level of skill in the art and are hereby incorporated by reference in their entirety.

### EXAMPLES

Materials and Methods for Examples 1-3

Animals

Adult male inbred PVG (RT1^{c}) and ACI (RT1^{a}) rats weighing between 200 and 250 g were purchased from Harlan Sprague-Dawley (Indianapolis, Ind.). The PVG rats were used as allograft donors, and the ACI rats were used as recipients. All rats were kept under standard temperature, humidity and timed lighting conditions and provided rat chow and water ad libitum. Animals were housed and cared for in compliance with the “Guide for the Care and Use of Laboratory Animals” prepared by the Institute of Laboratory Animal Resources, National Research Council, and published by the National Academy Press (revised 1996).

Heterotopic Cardiac Transplantation

Donor PVG hearts were heterotopically transplantedinto the abdomen of ACI recipients as previously described by Ono, K. and Lindsey, E. S. J. Thorac. Cardiovasc. Surg. 57:225-229 (1969). Briefly, the donor heart was induced into cardiac arrest by injection of ice-cold high potassium cardioplegia solution into the aortic root. The procured hearts were allowed to incubate in a bath of cold saline. After the recipient was anesthetized with 2.5% inhalational isoflurane (Halocarbon Laboratories, River Edge, N.J.) and 40 mg/kg intraperitoneal sodium pentobarbital (Abbot Laboratories, North Chicago, Ill.), the donor ascending aorta and pulmonary artery were anastomosed to the infra-renal abdominal aorta and inferior vena cava, respectively.

Drug Administration

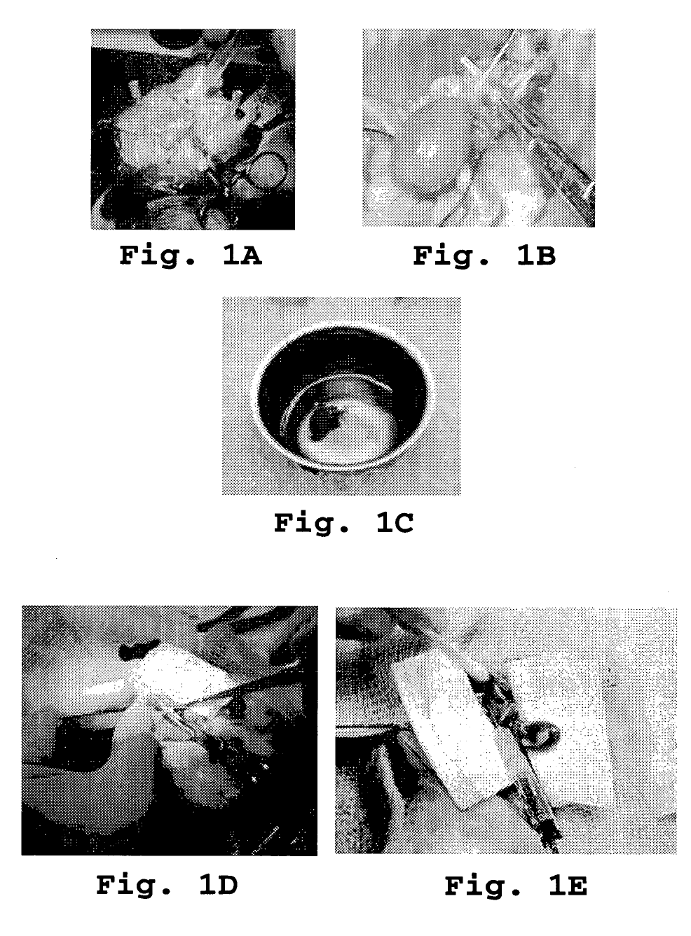

In the treated groups, after cardioplegic arrest of the donor heart and ligation of the ascending aorta, 2 mL of εPKC activator (ψεRACK; 1.5 nmol) solution was injected antegrade into the coronary artery system. Hearts were then procured and submerged in εPKC activator (ψεRACK; 0.5 μM) solution for 10 or 100 minutes at 4° C. Since standard graft implantation averages approximately 20 minutes, total ischemic times were 30 and 120 minutes. Prior to reperfusion of the donor heart, 1 mL of δPKC inhibitor (δV1-1; 30 nmol) solution was injected into the recipient IVC. Control animals were treated with normal saline (FIG. 1).

Experimental Groups

This was a two-part study. In the first part, indicators of ischemia-reperfusion injury were analyzed after 4 hours of reperfusion (n=6, each ischemic time). In the second part, GCAD was evaluated at 90 days (n=8, each ischemic time). In the latter group, recipients received cyclosporine A (7.5 mg/kg oral gavage) on postoperative days 0 to 9 to inhibit acute rejection.

Superoxide Production

Superoxide levels were measured in excised tissue by the spin trap method after 4 hours of reperfusion. Superoxide accumulation was measured using conditioned medium supplemented with the spin trapping agent, 4-amino-2,2,6,6,-tetramethylpiperidine-1-oxyl (tempamine, Sigma-Aldrich, St. Louis, Mo.), as previously described in Uemura, S. et al., Circ. Res. 88:1291-1298 (2001). Electron paramagnetic resonance (EPR) spectra were recorded at room temperature with a spectrometer (Model 8400, Resonance Instruments). The EPR signal intensity was quantified by comparing the double integration of the recorded first derivative EPR peaks of each sample with that of a standard tempamine spin solution. When tempamine reacts with other radical species such as superoxide, it loses its EPR signal. Thus, the reduction in peak height is directly proportional to the amount of superoxide produced. All measurements were normalized to the protein concentration of each sample as determined by the bicinchoninic acid (BCA) method (Pierce Chemical, Rockford, Ill.).

In Situ Oligo Ligation Terminal Deoxynucleotidyl Transferase-Mediated dUTP Nick End-Labeling Analysis (ISOL TUNEL)

Apoptotic cardiomyocyte counts in allograft tissues were determined by in situ staining of DNA strand breaks in serial sections of each specimen with the use of an ApopTag in situ oligo ligation (ISOL) kit with oligo A (Intergen, Purchase, N.Y.), as previously described in Chen, Z. et al., Am J. Physiol. Heart Circ. Physiol. 280:H2313-2320 (2001). Because the conventional TUNEL assay can detect non-specific DNA fragmentation due to necrosis, a more specific in situ ligation assay for identification of apoptotic nuclei was used with hairpin oligonucleotide probes. Cardiomyocyte apoptosis were confirmed by double staining the sections with α-sarcomeric actin (Sigma, St. Louis, Mo.). The number of TUNEL-positive cardiomyocytes in each cardiac allograft were counted manually by two investigators blinded to the experimental conditions. Cells were counted in six animals (4 fields each) at ×200 magnification. The percentage of TUNEL-stained cells was recorded, i.e., the number of labeled nuclei divided by total number of nuclei.

ELISA, Caspase Activity and MPO Assays

Snap-frozen myocardial tissue specimens were homogenized in PBS and centrifuged at 12000 g for 20 minutes at 4° C. The protein concentration of the supernatant was determined by the BCA method, and aliquots were stored at −80° C. Intragraft tumor necrosis factor-α(TNF-α), interleukin-1β (IL-1β, monocyte/macrophage chemoattractant protein-1 (MCP-1/CCL2) (BioSource International, Camarillo, Calif.), caspase-2,-8, and -9 activity assay kits were obtained from R&D Systems (Minneapolis, Minn.). Caspase-3 activity assay kit was purchased from BD Biosciences (Palo Alto, Calif.). MPO activity as units per milligram of total protein was assessed in lysates of reperfused cardiac allografts as previously described in Mullane, K. M., et al., J. Pharmacol. Methods 14:157-167 (1985).

Morphometric Analysis of GCAD

At 90 days after transplantation, the cardiac grafts were harvested and embedded in paraffin. Elastica von Gieson staining was done for morphometric analysis of arterial intimal proliferation, which was performed as described before in Armstrong, A. T., et al. Transplantation 63:941-947 (1997). Briefly, the neointima, media, and lumen were measured with the use of SPOT Advanced Version 3.4.2 software (Diagnostic Instruments, Inc. Sterling Heights, Mich.). The neointima was defined as the area bound by the internal elastic lamina, the media as the region between the internal and external elastic membranes, and the lumen as the clear region in the vessel. Diseased vessels were identified by greater than 10% luminal narrowing. Multiple sections from the middle of the heart were used for analysis. Middle-sized coronary arteries were analyzed (more than 10 arteries for each graft).

Statistical Analysis

All results are expressed as mean±SE. Data were compared, and between-group differences were analyzed by ANOVA with a post hoc Bonferroni test. Statistical analyses were performed with Stat View 5.0 (SAS Institute, Cary, N.C.), and significance was accepted at p<0.05.

### Example 1

### Effect of Treatment With PKC Regulators During Ischemia-Reperfusion Injury On Superoxide Production and Cardiomyocyte Apoptosis

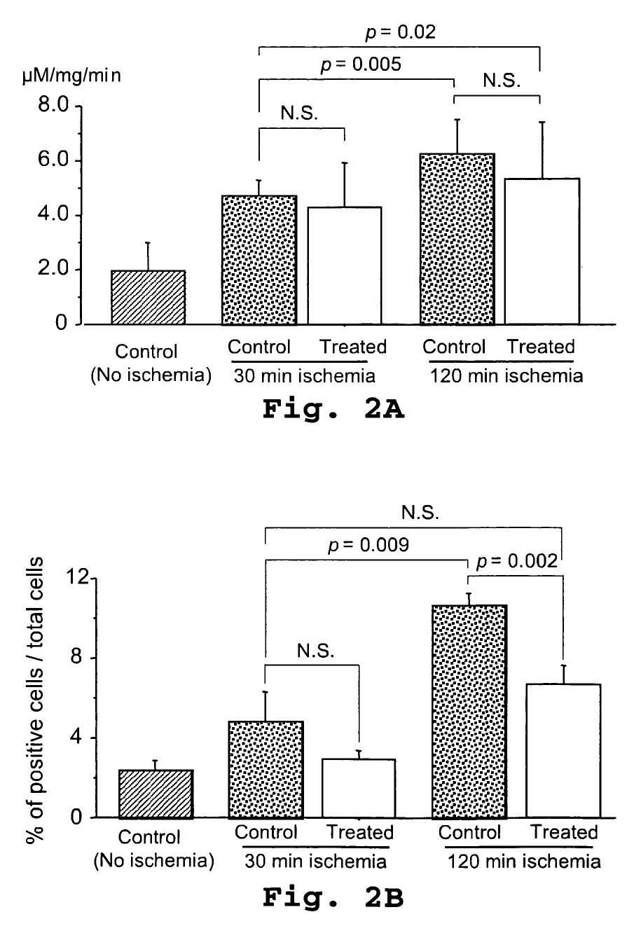

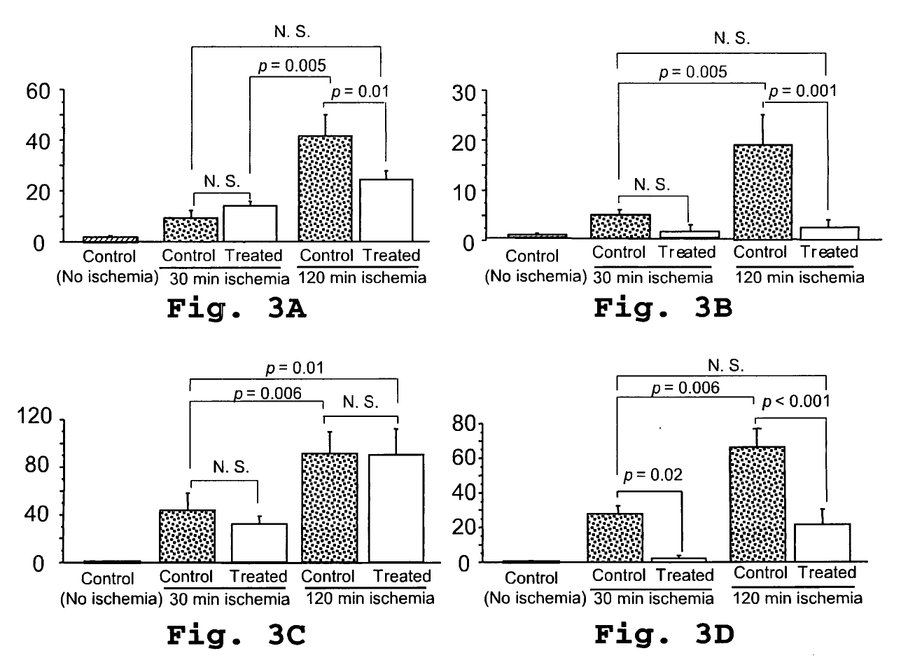

This example shows that cardiomyocte apoptosis was decreased when a heart was transplanted from a donor rat to a recipient rat and the rats were treated as described in the materials and methods section. This example further shows that superoxide production was unaffected in the rats. FIG. 1 illustrates the procedure and indicates the route of delivery and identity of the PKC regulating peptide used. Due to the length of the procedure, the minimal ischemic time for the transplanted organ was 30 minutes. Therefore, these hearts were compared to hearts kept ischemic for a total of 120 minutes. Superoxide production was measured first because myocardial injury following ischemia-reperfusion is mediated by oxygen-derived free radicals such as superoxide anion [Hess, M. L., and Kukreja, R. C. Ann. Thorac. Surg. 60:760-766 (1995)]. Four hours after reperfusion, a 1.3-fold increase in superoxide production was found in the transplanted hearts after 120 minutes ischemia as compared to the hearts subjected to a 30-minute ischemia in both the PKC regulator-treated and the control groups. However, similar production of superoxide occurred in both treatment and control groups (FIG. 2A).

Because ischemia-reperfusion injury causes cardiomyocyte apoptosis in the cardiac allografts, [Zhao, Z. Q. et al., Cardiovasc. Res. 45:651-660 (2000)] the next step was to determine the number of cardiomyocyte apoptosis in cardiac allografts. Four hours after reperfusion, the number of apoptotic cardiomyocytes increased 2.2 fold in the control group subjected to a total of 120 minutes ischemia as compared to the control group subjected to 30 minutes ischemia. In addition, the PKC regulators treatments reduced the number of apoptotic cardiomyocytes in cardiac allografts subjected to 120 minutes of ischemia by about 40%, similar to those observed in cardiac allografts subjected to only 30 minutes of ischemia (FIG. 2B).

Paralleling the increased number of apoptotic cardiomyocytes, the caspase-2, -3, -8, and -9 activities were significantly increased in the control group subjected to 120 minutes of ischemia as compared to the 30-minute ischemic controls (4.5-, 4.1-, 2.1-, and a 2.4-fold increase in caspase-2, -3, -8, and -9, respectively, FIG. 3). Following 30 minutes of ischemia, caspase-9 activity but not caspase-2, -3, or -8 activities significantly decreased in the PKC regulator-treated group as compared to the control group (FIG. 3). However, it was found that PKC-regulators treatments decreased caspase-2, -3 and -9 activities by 42%, 88%, and 67%, respectively, but not caspase-8 activity as compared to the 120-minute ischemic controls (FIG. 3). Furthermore, treatment with PKC regulators reduced caspase-2, -3, and -9 activities in the 120-minute ischemic group to the levels found in hearts subjected to only 30 minutes of ischemia. Therefore, in the transplanted heart subjected to prolonged ischemia, treatment with εPKC activator δPKC inhibitor reduces caspase-2 and 9-mediated cardiomyocytes apoptosis to the levels observed after only a short ischemic period.

### Example 2

### Effect of Treatment With PKC Regulators During Prolonged Ischemia On the Resultant Pro-Inflammatory Response of Ischemia-Reperfusion Injury

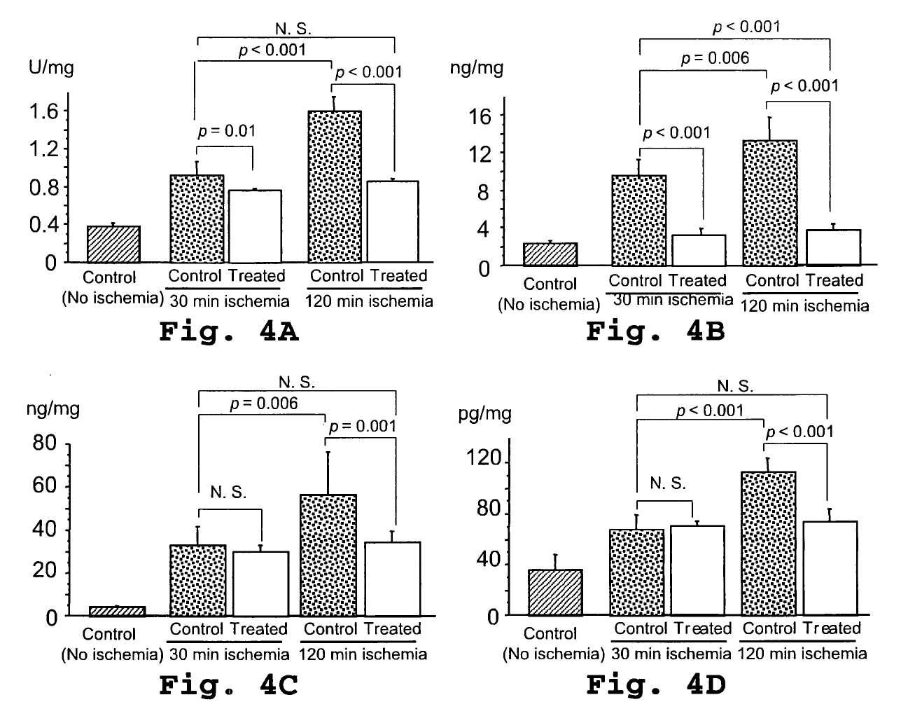

This example shows that treatment of heart donor rats and hear recipient rats with the PKC regulators described herein results in a decrease in the pro-inflammatory response mediated by certain chemokines and cytokines. Ischemia-reperfusion injury also produces a pro-inflammatory environment, which includes an influx of injurious cytokines and chemokines [Bergese, S. D. et al., Am. J. Pathol. 147:166-175 (1995)]. To determine whether treatment with the PKC regulators reduces the inflammatory response during prolonged ischemia, neutrophil-produced MPO was examined. Neutrophils are predominant effecter cells in the local inflammatory response [Zimmerli, W. et al., J. Clin Invest. 73:1191-1200 (1984)]. The levels of the pro-inflammatory cytokines and chemokines, TNF-α, IL-1β, and MCP-1/CCL2 were also determined. Four hours after transplantation, the levels of MPO and the tested pro-inflammatory cytokines increased by 1.7-folds in the 120-minute ischemic controls compared to the 30-minute ischemic controls. The production of TNF-α significantly decreased in both PKC regulator-treated groups, whereas the production of IL-1β and MCP-1 only decreased (41% and 35%, respectively) in the 120-minute ischemic, PKC regulator-treated group (FIG. 4). Importantly, there were no significant differences in these inflammatory responses between the PKC regulator-treated group subjected to 120 minutes of ischemia and the 30-minute ischemic control group (FIG. 4). In addition to reducing caspase-2 and -9, PKC regulator treatment during prolonged ischemia also reduces cardiomyocyte apoptosis by minimizing the pro-inflammatory response, as measured by the reduction in cytokine levels.

### Example 3

### The Effect of Treatment With Selected PKC Regulators On Development of GCAD Stimulated By Prolonged Ischemia

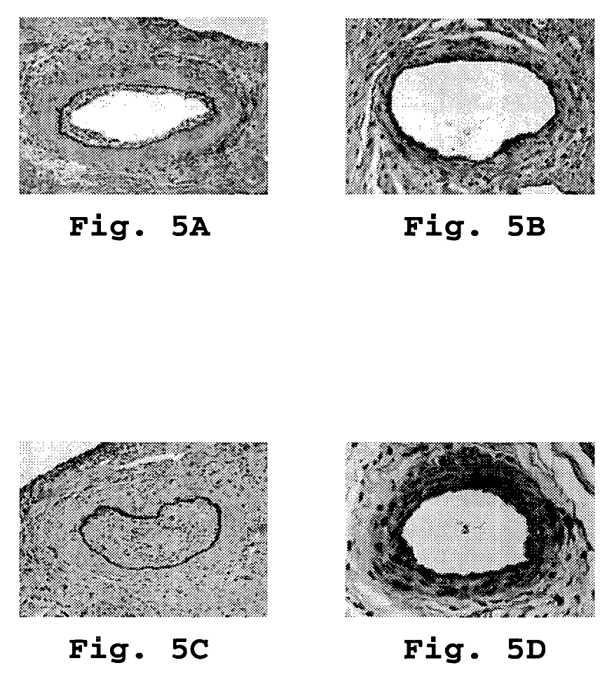

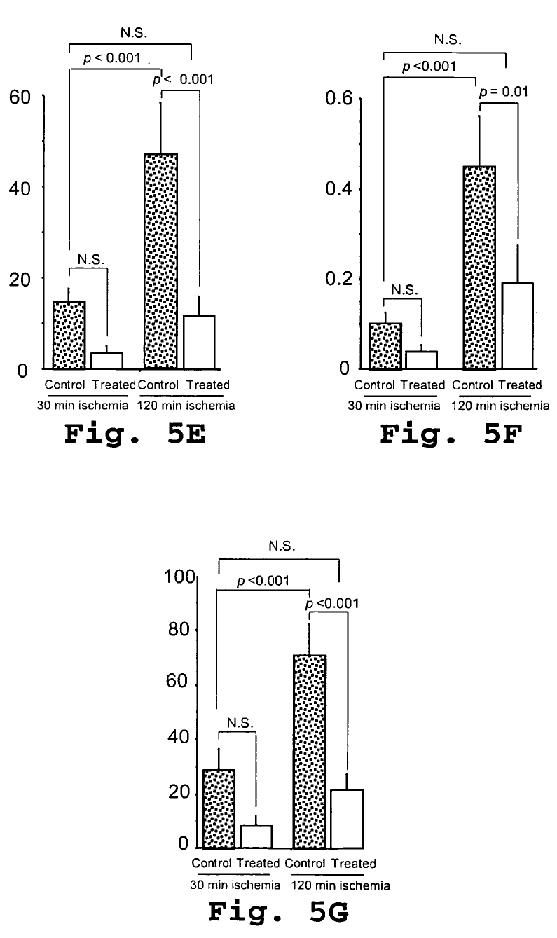

This example shows that treatment of heart donor rats and heart recipient rats with selected PKC regulators inhibits the development of GCAD stimulated by prolonged ischemia. It was first demonstrated that prolonged ischemia during organ procurement increases GCAD, as measured 90 days after transplantation (FIG. 5). A 3.2-fold increase in the luminal narrowing percentage, a 4.5-fold increase in the intima-to-media ratio and a 2.5 fold increase in the diseased vessel percentage were evident. Conversely, treatment with the PKC regulators during organ procurement and right at reperfusion inhibited GCAD in the cardiac allografts subjected to a 120-minute of ischemia; decreased the percentage of luminal narrowing by 78%, decreased the intima-to-media ratio by 58% and decreased the percentage of diseased vessels by 68% 90 days after transplantation (FIG. 5).

Discussion Related to Examples 1-3

In the present study, the acute consequences of εPKC and δPKC treatment during brief (30 minutes) or prolonged (120 minutes) procurement ischemia and the chronic result on the development of GCAD were examined. These PKC regulators reduce ischemia-reperfusion injury by two distinct means: εPKC activator delivered prior to and early during ischemia mimics ischemic preconditioning and δPKC inhibitor delivered at reperfusion has an anti-apoptotic effect. It was found herein that in control animals, 120 minutes of ischemia increased cardiomyocyte apoptosis, caspase-2, -3, -8, and -9 activities, inflammatory cytokine production, and neutrophil infiltration into the allografts as compared to the 30-minute ischemic control group. It was also found that aggravated cardiac damage with prolonged ischemia correlated with increased GCAD as measured 90 days after transplantation. In contrast, combined treatment with the δPKC-specific inhibitor (δV1-1) and the εPKC-specific activator (ψε-RACK) significantly suppressed ischemia-reperfusion injury and resulted in ˜70% reduction in GCAD. The protective effect of these PKC regulators was more significant in the prolonged ischemic group.

In addition, treatment with these PKC regulators reduced all the parameters related to ischemia-reperfusion injury and GCAD following prolonged ischemia to the level of those observed following the short period of ischemia. The PKC regulator-treated group with prolonged ischemia showed about a 70% decrease in production of pro-inflammatory cytokine TNF-α, and ˜40% decline in IL-1β, and MCP-1/CCL2. Significant decreases in MPO activity, cardiomyocytes apoptosis, and caspase-2, -3 and -9 activities were also observed. Importantly, the reduction in ischemia-reperfusion injury observed 4 hours after transplantation correlated with a reduction in the development of GCAD; there was a 70% decline in the severity of the disease in the PKC regulator-treated group as compared with control group.

In the present study, caspase -3 and -9 activities were significantly reduced in the PKC regulator-treated group with prolonged ischemia, whereas no significant reduction in caspase-8 was observed in PKC regulator-treated group after 30 and 120 minutes of ischemia. It is believed that apoptosis in the cardiac allograft was reduced mainly by inhibition of the caspase-9-mediated pro-apoptotic pathway.

Oxygen free radicals are directly implicated in pathologic apoptosis [Greenlund, L. J., et al., Neuron 14:303-315 (1995)]. A significant increase in both superoxide production and cardiomyocyte apoptosis with prolonged ischemia was observed herein in comparison to that with a short ischemic period. However, there was no significant reduction in superoxide production in the PKC regulator-treated group in comparison to the saline treated-control group subjected to either 30 or 120 minutes of ischemia suggesting that this early burst of superoxide production is independent of 6 and εPKC. The role of caspase-2 in apoptosis is still unclear, [Troy, C. M. and Shelanski, M. L. Cell Death Differ. 10:101-107 (2003)] but caspase-3 activation by caspase-2 has been reported to involve caspase-9 activation [Robertson, J. D., et al., J. Biol. Chem. 277:29803-29809 (2002)]. A significant increase in caspase-2, -3, and -9 activities was observed after prolonged ischemia, and this was significantly decreased after PKC regulator treatment. This is the first report that shows a suppressive effect by selective PKC regulators on caspase-2 activity in an in vivo heart transplantation model. However, the mechanistic basis for interactions of δ and εPKC isozymes and caspase-2 activation, and interactions of caspase-2 and downstream caspases in the experimental model described herein remain to be elucidated.

Most importantly, GCAD was significantly reduced at 90 days post-transplantation after PKC-regulator treatment. This reduction following 120 minutes of ischemia was comparable to the level of GCAD following 30 minutes of ischemia. Since the half-life of the PKC-regulation peptides is very short, the reduction in GCAD that was observed herein following the 120-minute ischemia most likely occurred due to the acute reduction in ischemia-reperfusion injury in the early phase. The early cell-protective effect might have resulted in a decreased production of pro-inflammatory cytokines in the cardiac allograft, which in turn lead to a decreased GCAD.

Although this study used an allogenic model of heart transplantation as a model of cardiac transplantation in humans, the ischemic period of 120 minutes is shorter than the mean ischemic time occurring in humans (3.1 hours) [Taylor, D. O., et al., J. Heart Lung Transplant 22:616-624 (2003)]. Nevertheless, the GCAD progression in the rodent model is accelerated relative to that seen in humans [Tanaka, M. et al., J. Heart Lung Transplant, in press, (2004)]. and therefore may be useful to begin assessing new therapeutics to prolong graft survival in recipients. In addition, this model examined sequential treatment of the donor heart with the εPKC activator in the cardioplegic solution followed by treatment with the δPKC inhibitor in the recipient rat just prior to reperfusion. Although these PKC-regulators did not exert significant effect on most of the measured parameters as compared with the saline-treated controls, in allografts subjected to a short ischemic insult (30 minutes), there were trends of reduction in ischemia-reperfusion injury and GCAD in the PKC regulator-treated group as compared with saline-treated controls. The differences between the PKC regulator-treated group and the saline-treated controls became more apparent with increased ischemia-reperfusion injury and GCAD caused by prolonged ischemia (120 minutes).

In conclusion, the results reported herein suggest that GCAD and possibly organ failure induced by prolonged ischemia of the donor heart may be inhibited by combined treatment with an εPKC activator and a δPKC inhibitor in clinical cardiac transplantation.

Materials and Methods for Examples 4-6

Animals

Male FVB (H-2^{q}) and C57BL/6 (H-2^{b}) mice, 6-10 weeks old, were purchased from Jackson Laboratory (Bar Harbor, Me.) and housed at the animal care facility at Stanford University Medical Center (Stanford, Calif.). The FVB mice were used as allograft donors, and the C57BL/6 mice were used as recipients. All mice were kept under standard temperature, humidity, and timed lighting conditions and provided mouse chow and water ad libitum. Animals were treated in compliance with the “Guide for the Care and Use of Laboratory Animals” prepared by the Institute of Laboratory Animal Resources, National Research Council, and published by the National Academy Press (revised 1996).

Heterotopic Cardiac Transplantation

Heterotopic cardiac transplantation was performed according to the method of Corry et al⁹ with some modifications. Anesthesia was induced with 5% inhaled isoflurane (Halocarbon Laboratories, River Edge, N.J.). During surgery, the animals were maintained on 2.5% inhaled isoflurane. Donor animals were systemically heparinized (50 mg/kg) before heart procurement. The donor heart was rapidly excised after coronary perfusion with ice-cold saline. The procured hearts were kept in ice-cold saline for 20 minutes. Since standard graft implantation averages approximately 30 minutes, the total ischemic time was 50 minutes.

Drug Administration

εPKC agonist (ψεRACK) was injected intraperitoneally (20 nmol) into the donor mice 20 minutes before heart procurement. During procurement, the donor hearts were perfused with 3 ml of ψεRACK (1.5 nmol) through the inferior vena cava (IVC). T he procured hearts were then submerged in the same drug solution (0.5 μM) for 20 minutes at 4° C. Prior to reperfusion, the peritoneal cavity of recipients was irrigated with δPKC antagonist (δV1-1; 300 nmol) solution. Control animals were treated with normal saline.

Experimental Groups

The study was of two parts. First, indicators of ischemia-reperfusion injury were analyzed after 2 hours of reperfusion (PKC regulator-treated vs. control mice, n=6 each group). Second, GCAD was evaluated at 30 days (PKC regulator-treated vs. control mice, n=7 each group). In the 30 days follow up (chronic study), recipients in both PKC regulator-treated group and control group received daily cyclosporine A (20 mg/kg/day) by intraperitoneal injection.

In Situ Oligo Ligation Terminal Deoxynucleotidyl Transferase-Mediated dUTP Nick End-Labeling Analysis (ISOL TUNEL)

This analysis was performed as described in the Materials and Methods section for Examples 1-3 above, with the exception that the cardiomyocyte apoptosis was verified by staining once with α-sarcomeric actin.

ELISA, Caspase Activity and MPO Assays

Intragraft tumor necrosis factor-α (TNF-α, interleukin-1β (IL-1β, monocyte/macrophage chemoattractant protein-1 (MCP-1/CCL2), interferon-γ (IFN-γ) (BioSource International, Camarillo, Calif.), Fas, Fas ligand (FasL), IFN-γ induced protein-10 (IP-10/CXCL10), monokine induced by IFN-γ (MIG/CXCL9), intracellular adhesion molecule-1 (ICAM-1), vascular cellular adhesion molecule-1 (VCAM-1) and caspase-8 and -9 activity assay kits were obtained from R&D Systems (Minneapolis, Minn.). Caspase-3 activity assay kit was purchased from BD Biosciences (Palo Alto, Calif.). MPO activity as units per milligram of total protein was assessed in lysates of reperfused cardiac grafts as previously described in Mullane, K. M., et al. J. Pharmacol. Methods 14:157-167 (1985).

Graft Survival and Allograft Function Analyses

Mice in the second part of this study were monitored daily. Graft viability was assessed by direct abdominal palpation of the heterotopically transplanted heart. Cardiac graft function was expressed as the beating score, assessed by the Stanford cardiac surgery lab graft scoring system (0: no contraction, 1: contraction barely palpable, 2: obvious decrease in contraction strength but still contracting in a coordinated manner; rhythm disturbance, 3: strong, coordinated beat but noticeable decrease in strength or rate; distention/stiffness, 4: strong contraction of both ventricles, regular rate, no enlargement or stiffness).

Morphometric Analysis of GCAD

This analysis was performed as described in the Materials and Methods section for Examples 1-3, with the exception that the grafts were harvested at 30 days after transplantation and, in analyzing middle-sized coronary arteries, more than 8 arteries for each graft were analyzed.

Statistical Analysis

Values are expressed as mean±SD. All comparisons shown are between SOD1 transgenic donor heart recipients and wild-type littermate donor heart recipients. Differences in values were analyzed statistically by the unpaired student's t-test and the differences in cardiac graft beating score were analyzed by a 2-way repeated-measures ANOVA (StatView 5.0; SAS Institute, Cary, N.C.). Significance was accepted at p<0.05.

### Example 4

### The Effect of Treatment of Heart Donor Mice and Heart Recipient Mice With PKC Regulators On Cardiomyocyte Apoptosis and Inflammation Caused By Ischemia-Reperfusion Injury in Cardiac Allografts

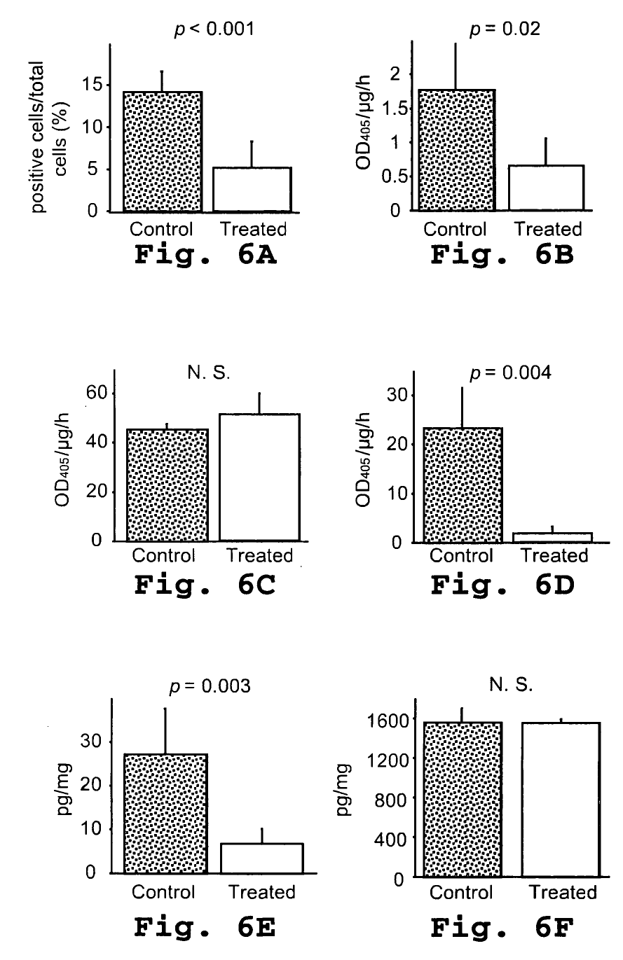

This example shows that treatment of heart donor mice and heart receipient mice with the PKC regulators described herein suppressed cardiomyocite apoptosis and inflammation caused by ischemia-reperfusion injury in cardiac allografts. Ischemia-reperfusion injury causes cardiomyocyte apoptosis in the cardiac grafts as determined by Zhao, Z. Q. et al. Cariovasc. Res 45:651-660 (2000). Two hours after transplantation, ISOL TUNEL positive apoptotic cardiomyocyte significantly decreased by about 65% in cardiac allografts of the PKC regulator-treated group compared with that of the control group (FIG. 6-A).

A corresponding decrease in caspase-3 and caspase-9 activities was also found in the PKC regulator-treated group when compared to those from the control group (FIG. 6-B and D). However, there was no significant difference in caspase-8 activity between these two groups (FIG. 6-C).

FasL level was significantly decreased in the cardiac allograft of PKC regulator-treated group (FIG. 6-E), while Fas expression did not differ between these two groups (FIG. 6-F). These results suggest that treatment with both PKC regulators leads to inhibition of cardiomyocyte apoptosis mediated by a caspase-3 and -9 dependent pathway.

It was determined whether treatment with the selected PKC regulators reduces the inflammatory response following transplantation. Neutrophil-produced MPO was examined because neutrophils are known as predominant effecter cells in the local inflammatory response. Zimmerli, W. et al. J. Clin Invest. 73:1191-1200 (1984). The levels of the pro-inflammatory cytokines and chemokines, TNF-α, IL-1β, and MCP-1/CCL2 were also determined.

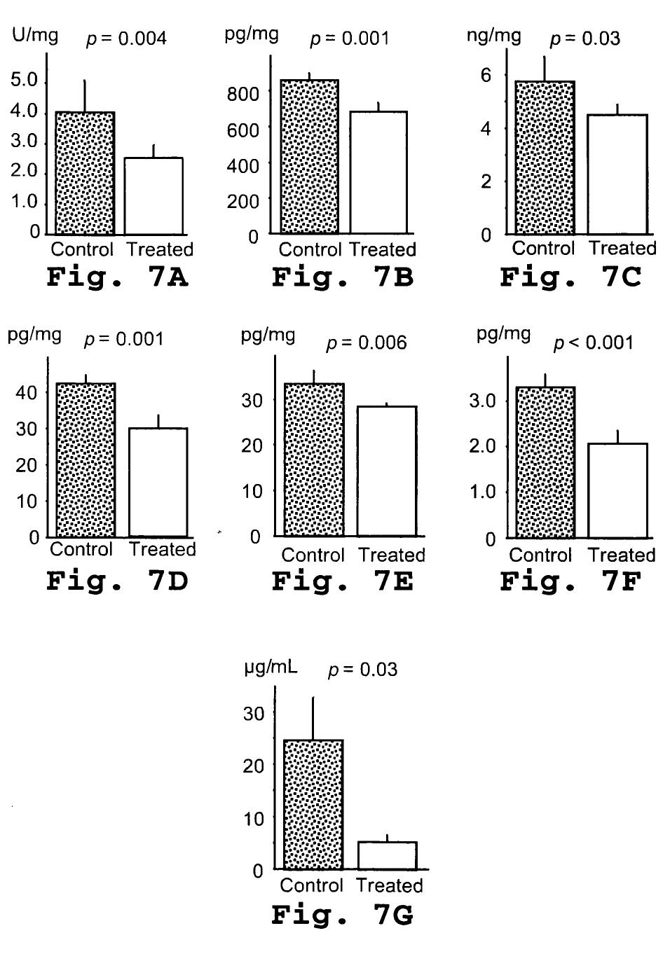

The levels of MPO, and the tested pro-inflammatory cytokines were all significantly lower in the cardiac allografts of the PKC regulator-treated group as compared to the control group two hours after transplantation (FIG. 7-A-D).

In addition, the levels of ICAM-1 and VCAM-1 in the cardiac allografts were also significantly decreased in PKC regulator-treated group compared to control group at the time tested (FIG. 7-E, F).

Moreover, the serum levels of CPK-MB were significantly lower in the SOD1 transgenic donor heart recipients compared to the wild-type donor heart recipients four hours of reperfusion, indicating decreased cardiac graft necrosis (FIG. 7-G). Taken together, these results suggest that treatment with the PKC regulators inhibits cell apoptosis mediated by caspases and inflammation in the early phase after ischemia-reperfusion injury to cardiac allografts.

### Example 5

### The Effect of Treatment of Heart Donor Mice and Heart Recipient Mice On Cardiac Allograft Function, Local Cytokine Production and GCAD

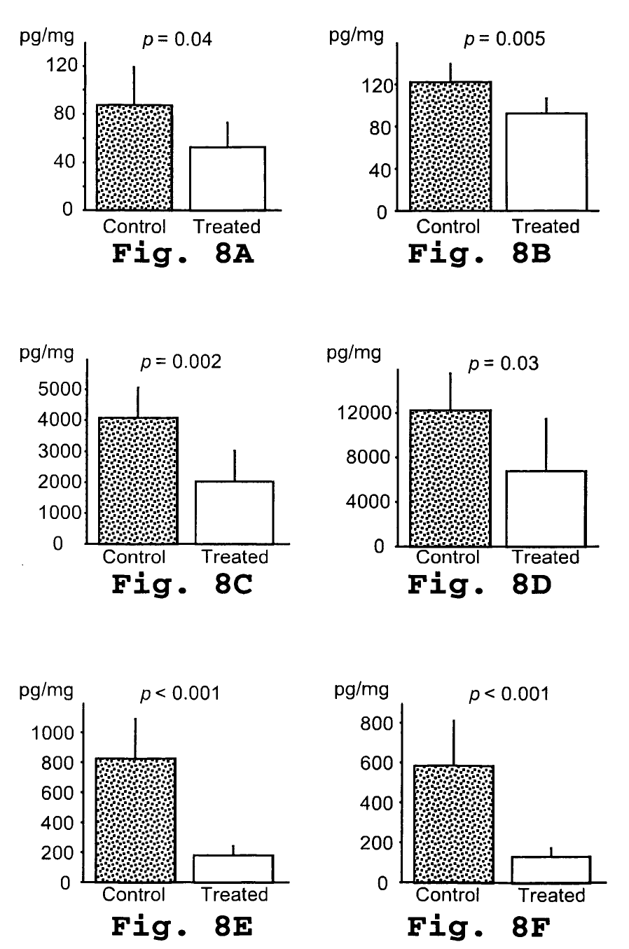

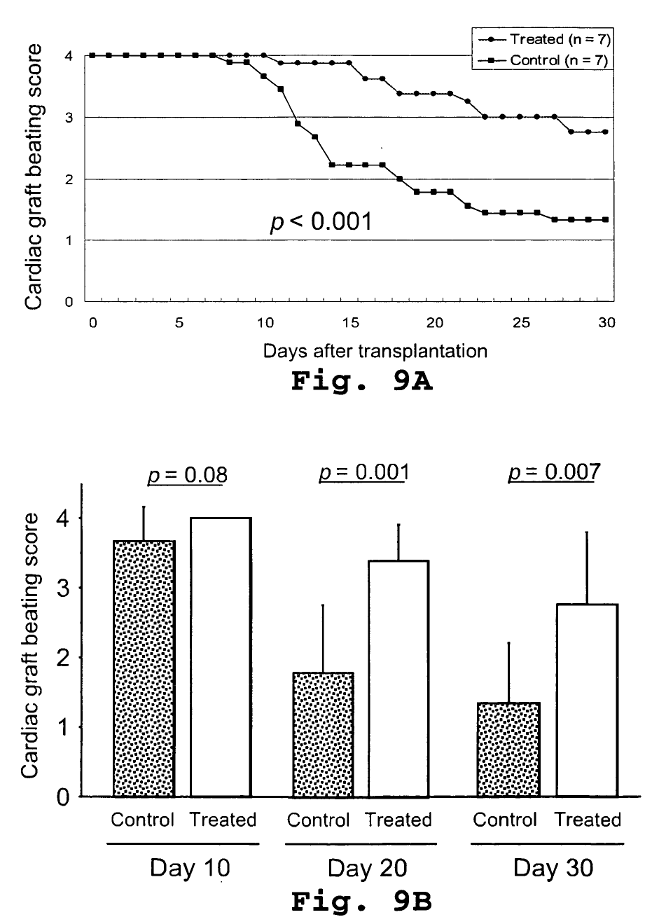

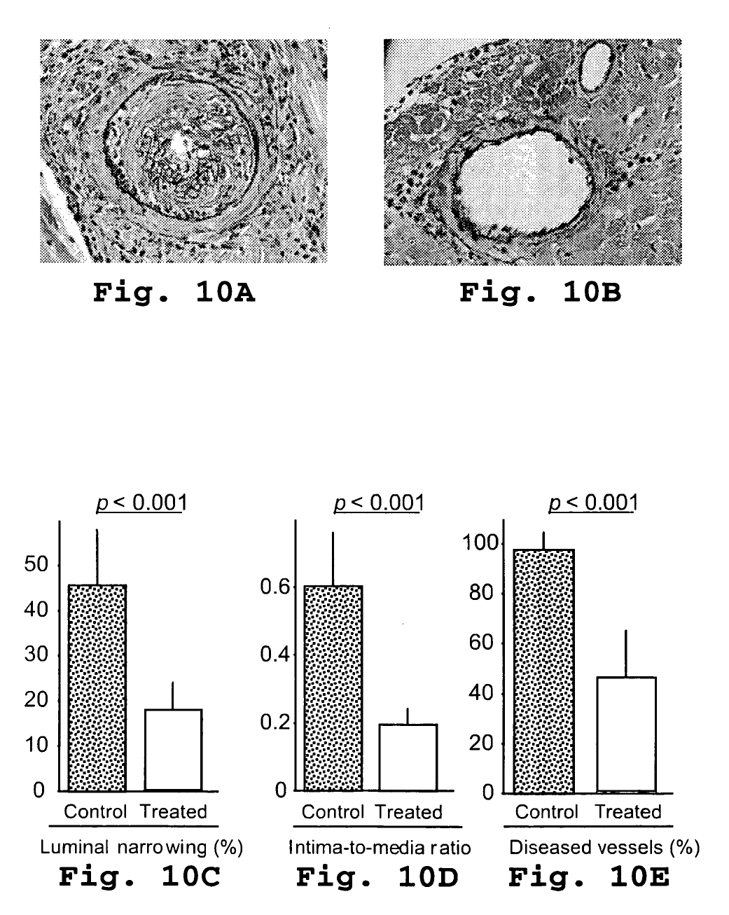

This example demonstrates that treatment of heart donor mice and heart recipient mice with the PKC regulators described herein improves cardiac allograft function and reduces local cytokine production and GCAD. It was found that production of IFN-γ, and the chemokines MCP-1/CCL2, IP-10/CXCL10, and MIG/CXCL9, and the expression of adhesion molecules ICAM-1 and VCAM-1 were all significantly lower in the cardiac allograft of the PKC regulator-treated group compared to control group at 30 days after transplantation (FIG. 8). Graft beating scores were significantly better in the PKC regulator-treated group at both 20 and 30 days after transplantation (FIG. 9). Marked fibrointimal thickening and luminal narrowing, morphologically resembling typical human GCAD, were observed in the control group. In contrast, less intimal thickening and preserved vessel lumen were observed in the PKC regulator-treated group (FIG. 10-A). Importantly, GCAD, assessed by the mean percentage of luminal narrowing, the intima-to-media ratio, and the percentage of diseased vessels, was significantly less in the PKC regulator-treated group compared to the control group (FIG. 10-B). Therefore, treatment with the PKC regulators reduced production of cytokine, chemokines, adhesion molecules in the cardiac allograft in the chronic phase. This reduction correlated with a greater than 60% reduction in coronary artery disease in the allografts and a dramatic increase in cardiac function.

Discussion for Examples 4 and 5

The goal of this study was to determine whether inhibition of ischemia-reperfusion injury by a brief treatment with an εPKC activator and a δPKC inhibitor during tissue procurement and transplantation would reduce GCAD in murine cardiac allografts. It was determined that treatment with these PKC-selective regulators reduced acute cytokine production (measured two hours after transplantation) and reduced cardiomyocyte apoptosis and caspase-3 and -9 activities. Importantly, this treatment resulted in improved cardiac function and reduced coronary artery disease in the allograft. It is suggest herein that inhibition of ischemia-reperfusion injury reduced production of inflammatory cytokines, chemokines, and adhesion molecules in the early phase after transplantation, which in turn led to reduction of GCAD in the chronic phase.

It is suggested herein that the combined treatment with εPKC-specific activator and δPKC-specific inhibitor decreases ischemia-reperfusion injury to the allograft by two distinct means: an ischemic preconditioning mimetic effect of the εPKC activator, given to the donor before organ harvest and during organ procurement, and an anti-apoptotic effect of the δPKC inhibitor, given to the recipient just before the onset of reperfusion of the transplanted heart.

The apoptotic process involves a complex series of signal transduction and cell activation steps including the mitochondria disruption-mediated stress pathway on one hand and the Fas and TNF receptor-mediated death receptor pathway, on the other. [Nunez, G. et al. Oncogene 17:3237-3245 (1998)]. The mitochondria disruption-mediated stress pathway involves the release of cytochrome c from the mitochondria into the cytosol and subsequent caspase-9 and caspase-3 activation, and the Fas and TNF receptor-mediated death receptor pathway, such as Fas/Fas-ligand binding leads to caspase-8 and then caspase-3 activation. Nunez, G. et al., supra. Activated caspase-3 then cleaves substrates, such as poly-(ADP-ribose) polymerase, leading to DNA fragmentation and apoptosis.

In the present study, caspase-3 and -9 activities were significantly reduced in PKC regulator-treated grafts during ischemia-reperfusion injury, but no significant reduction in caspase-8 was observed. In addition, level of Fas ligand but not Fas was significantly decreased. Thus it appears that, under PKC regulators treatment, cardiomyocyte apoptosis is reduced mainly by inhibition of the caspase-9-mediated pathway.

In this study, significantly reduced GCAD was observed at 30 days after transplantation in animals treated with the PKC regulating peptide just during the transplantation procedure. It is highly unlikely that the peptides remain active to exert an effect in the chronic phase, because the peptides have a very short half-life after injection in vivo (unpublished data). It is therefore suggested herein that the reduction in GCAD observed in the chronic phase is due mainly to reduction of ischemia-reperfusion injury in the early phase after transplantation. In support of this suggestion, a significant decrease in IFN-γ and related chemokine production in the chronic phase was found herein.

In addition, a significant decrease in production of IFN-γ related chemokines was found herein, such as IP-10/CXCL10 and MIG/CXCL9 in the chronic phase. Thus, inter-stimulation of IFN-γ and IFN-γ-related chemokines may elaborate the immune response, contributing to the development of GCAD. Moreover, a significant decrease in MCP-1/CCL2 production was found herein. MCP-1/CCL2 is a potent chemokine secreted by activated endothelial and vascular smooth muscle cells as well as monocyte/macrophages in cardiac allografts, thereby contributing to the accumulation of these inflammatory cells within the expanding neointima [Koskinen, P. K. and Lemstrom, K. B., Circulation 95:191-196 (1997)]. Such MCP-1/CCL2-mediated effects appear to be an important step in the development of GCAD.

A significant decrease in the production of both ICAM-1 and VCAM-1 was observed during ischemia-reperfusion injury and in the chronic phase in mice treated with selective regulators of δ and εPKC.

In conclusion, treatment with selective PKC regulator peptides at the time of transplantation reduced apoptosis mainly by inhibiting the caspase-9- and -3-mediated pathway and suppression of pro-inflammatory response in murine cardiac allografts. Dissection of the related cell signaling events should have a major influence on the establishment of preventive and therapeutic approaches to ischemia-reperfusion injury during cardiac transplantation. Furthermore, the results herein point to a therapeutic potential of εPKC activator and δPKC inhibitor in combination for suppressing apoptosis and inflammatory response during ischemia-reperfusion injury, thereby suppressing GCAD. It may be possible to use these peptides clinically to improve both the short- and long-term function of cardiac allografts. The obtained results in this study are encouraging and suggest that GCAD can be greatly reduced by regulation of selective PKC isozymes during organ or tissue procurement and early reperfusion of the transplanted organs or tissue.

1. A method of reducing injury to a transplanted mammalian organ or tissue, comprising:
a) administering a therapeutically effective amount of a first composition comprising an agonist of ε protein kinase C and optionally an inhibitor of δ protein kinase C to an organ or tissue transplant donor prior to or during removal of an organ or tissue to be transplanted;
b) bathing said organ or tissue to be transplanted in a second composition comprising an agonist of ε protein kinase C and optionally an inhibitor of δ protein kinase C after removing said organ or tissue from said organ or tissue transplant donor; and
c) administering a therapeutically effective amount of a third composition comprising an inhibitor of δ protein kinase C and optionally an agonist of δ protein kinase C to an organ or tissue transplant recipient prior to, during or after implantation of said transplanted organ or tissue.

2. (canceled)

3. The method of claim 2, wherein said agonist is ψεRACK having an amino acid sequence having at least about 50% to 75% identity to the amino acid sequence set forth in SEQ ID NO:1.

4. (canceled)

5. The method of claim 2, wherein said agonist is ψεRACK having an amino acid sequence set forth in SEQ ID NO:1, a derivative of ψεRACK, a fragment of ψεRACK or a combination thereof.

6-7. (canceled)

8. The method of claim 7, wherein said inhibitor has an amino acid sequence having at least about 50% identity to the amino acid sequence of δV1-1 set forth in SEQ ID NO:15, at least about 50% identity to the amino acid sequence of δV1-2 set forth in SEQ ID NO:16, or at least about 50% identity to the amino acid sequence δV1-5 set forth in SEQ ID NO:17, or a combination thereof.

9-10. (canceled)

11. The method of claim 1, wherein said transplanted organ is a heart, kidney, liver, pancreas, lung, heart, or intestine and said organ transplant donor is a heart transplant donor.

12. The method of claim 11, further comprising inducing arrest of said heart prior to said administering a therapeutically effective amount of said first composition to said heart transplant donor.

13. The method of claim 12, wherein said administering a therapeutically effective amount of said third composition to a heart transplant recipient occurs prior to reperfusion of the transplanted heart.

14. (canceled)

15. The method of claim 1, where at least one of said activator of ε protein kinase C or said inhibitor of δ protein kinase C in said first, second or third composition is conjugated to a carrier peptide.

16. The method of claim 15, wherein said carrier peptide has the amino acid sequence set forth in SEQ ID NO:58 or SEQ ID NO:59.

17. The method of claim 1, wherein at least one of said inhibitor of δ protein kinase C or said agonist of ε protein kinase C in said first or third composition is administered intravenously or intraarterially.

18-19. (canceled)

20. The method of claim 1, wherein said administering a therapeutically effective amount of said first composition is performed by introducing said agonist into an artery of said organ to be transplanted in said organ transplant donor, and wherein said administering a therapeutically effective amount of said third composition is performed by introducing said agonist into a vein of said transplant recipient.

21. (canceled)

22. A method of inhibiting development of graft disease in a mammalian blood vessel, comprising:
a) administering a therapeutically effective amount of a first composition comprising an agonist of ε protein kinase C and optionally an inhibitor of δ protein kinase C to an organ or tissue transplant donor prior to or during removal of an organ or tissue to be transplanted;
b) bathing said organ or tissue to be transplanted in a second composition comprising an agonist of ε protein kinase C and optionally an inhibitor of δ protein kinase C after removing said organ or tissue from said organ or tissue transplant donor; and
c) administering a therapeutically effective amount of a third composition comprising an inhibitor of δ protein kinase C and optionally an agonist of ε protein kinase C to an organ or tissue transplant recipient prior to, during or after implantation of said transplanted organ or tissue.

23. The method of claim 22, wherein said blood vessel is an artery or a vein.

24. The method of claim 23, wherein said artery is a coronary artery, said organ transplant donor is a heart transplant donor and said organ transplant recipient is a heart transplant recipient.

25. The method of claim 22, wherein said agonist of ε protein kinase C in said first, second and third compositions is a peptide agonist.

26. The method of claim 25, wherein said peptide agonist is ψεRACK having an amino acid sequence having at least about 50% to 75% identity to the amino acid sequence set forth in SEQ ID NO:1.

27. (canceled)

28. The method of claim 25, wherein said peptide agonist is ψεRACK having an amino acid sequence set forth in SEQ ID NO:1.

29. (canceled)

30. The method of claim 22, wherein said inhibitor of δ protein kinase C in said first, second and third compositions is a peptide inhibitor.

31. The method of claim 30, wherein said peptide has an amino acid sequence having at least about 50% identity to the amino acid sequence of δV1-1 set forth in SEQ ID NO:15, at least about 50% identity to the amino acid sequence of δV1-2 set forth in SEQ ID NO:16, or at least about 50% identity to the amino acid sequence of δV1-5 set forth in SEQ ID NO:17.

32-33. (canceled)

34. The method of claim 22, wherein at least one of said inhibitor of δ protein kinase C or said agonist of δ protein kinase C in said first and third compositions is administered intravenously or intraarterially.

35. The method of claim 22, wherein administering said first composition to said organ or tissue transplant donor occurs prior to removal of an organ or tissue to be transplanted.

36. The method of claim 22, wherein said administering a therapeutically effective amount of said third composition to said organ or tissue transplant recipient occurs prior to reperfusion of said transplanted organ or tissue.

37. (canceled)

38. A method of decreasing an inflammatory response in a mammal, comprising:
a) administering a therapeutically effective amount of an agonist of ε protein kinase C, an inhibitor of δ protein kinase C, or a combination thereof, to a patient in need thereof prior to, during or after an event giving rise to an inflammatory response.

39. The method of claim 38, wherein said event is an ischemic event.

40. (canceled)

41. The method of claim 40, wherein said chemokine is monocyte chemoattractant protein-1 (MCP-1/CCL2), Interferon-inducible protein 10 (IP-10/CXCL10), monokine induced by interferon γ (MIG/CXCL9), or a combination thereof.

42. (canceled)

43. The method of claim 42, wherein said cytokine is tumor necrosis factor-α (TNF-α), interleukin-1β (IL-1β), interferon γ, or a combination thereof.

44. (canceled)

45. The method of claim 44, wherein said at least one adhesion molecule is intracellular adhesion molecule-1 (I-CAM-1), vascular cell adhesion molecule-1 (V-CAM-1), or a combination thereof.

46. A method of inhibiting a pro-apoptotic event in a mammal, comprising:
administering a therapeutically effective amount of an agonist of ε protein kinase C and optionally an inhibitor of δ protein kinase C to a patient in need thereof.

47. (canceled)

48. The method of claim 47, wherein said inhibitor of protein kinase C is a peptide having an amino acid sequence having at least about 50% identity to the amino acid sequence of δV1-1 set forth in SEQ ID NO:15, at least about 50% identity to the amino acid sequence of δV1-2 set forth in SEQ ID NO:16, or at least about 50% identity to the amino acid sequence of δV1-5 set forth in SEQ ID NO:17, or a combination thereof.

49-50. (canceled)

51. The method of claim 46, wherein said pro-apoptotic event is activation or increased production of a caspase and said patient is administered a therapeutically effective amount of an agonist of ε protein kinase C and optionally an inhibitor of δ protein kinase C.

52-53. (canceled)

54. The method of claim 51, wherein said caspase is caspase-1, caspase-2, caspase-3, caspase-4, caspase-5, caspase-6, caspase-7, caspase-8, caspase-9, caspase-10, caspase-11, caspase-12, caspase-13, caspase-14, or a combination thereof.

55. (canceled)

56. The method of claim 55, wherein said ischemic event occurs during an organ or tissue transplantation procedure.

57. The method of claim 55, wherein said transplantation procedure is a heart transplantation procedure.


SEQUENCE LISTING (59 sequences)

SEQ ID NO: 1 - protein, 8 aa, Rattus norvegicus
HDAPIGYD

SEQ ID NO: 2 - protein, 8 aa, Artificial Sequence
  Synthetic Peptide
HEADIGYD

SEQ ID NO: 3 - protein, 8 aa, Artificial Sequence
  Synthetic Peptide
HDAPIGYE

SEQ ID NO: 4 - protein, 8 aa, Artificial Sequence
  Synthetic Peptide
HDAPVGYE

SEQ ID NO: 5 - protein, 8 aa, Artificial Sequence
  Synthetic Peptide
HDAPLGYE

SEQ ID NO: 6 - protein, 8 aa, Artificial Sequence
  Synthetic Peptide
HDAPIGDY

SEQ ID NO: 7 - protein, 8 aa, Artificial Sequence
  Synthetic Peptide
HDAPIGEY

SEQ ID NO: 8 - protein, 8 aa, Artificial Sequence
  Synthetic Peptide
ADAPIGYD

SEQ ID NO: 9 - protein, 8 aa, Artificial Sequence
  Synthetic Peptide
HDGPIGYD

SEQ ID NO: 10 - protein, 8 aa, Artificial Sequence
  Synthetic Peptide
HDAAIGYD

SEQ ID NO: 11 - protein, 8 aa, Artificial Sequence
  Synthetic Peptide
AEAPVGEY

SEQ ID NO: 12 - protein, 8 aa, Artificial Sequence
  Synthetic Peptide
HEAPIGDN

SEQ ID NO: 13 - protein, 8 aa, Artificial Sequence
  Synthetic Peptide
HDGDIGYD

SEQ ID NO: 14 - protein, 5 aa, Artificial Sequence
  Synthetic Peptide
DAPIG

SEQ ID NO: 15 - protein, 10 aa, Rattus norvegicus
SFNSYELGSL

SEQ ID NO: 16 - protein, 11 aa, Rattus norvegicus
ALTTDRGKTLV

SEQ ID NO: 17 - protein, 14 aa, Rattus norvegicus
KAEFWLDLQPQAKV

SEQ ID NO: 18 - protein, 58 aa, Artificial Sequence
  Synthetic Peptide
PFRPKVKSPRPYSNFDQEFLNEKARLSYSDKNLIDSMDQSAFAGFSFVNPKFEHLLED

SEQ ID NO: 19 - protein, 10 aa, Artificial Sequence
  Synthetic Peptide
TFNSYELGSL

SEQ ID NO: 20 - protein, 10 aa, Artificial Sequence
  Synthetic Peptide
AFNSYELGSL

SEQ ID NO: 21 - protein, 10 aa, Artificial Sequence
  Synthetic Peptide
SFNSYELGTL

SEQ ID NO: 22 - protein, 10 aa, Artificial Sequence
  Synthetic Peptide
TFNSYELGTL

SEQ ID NO: 23 - protein, 10 aa, Artificial Sequence
  Synthetic Peptide
SYNSYELGSL

SEQ ID NO: 24 - protein, 10 aa, Artificial Sequence
  Synthetic Peptide
SFNSFELGSL

SEQ ID NO: 25 - protein, 9 aa, Artificial Sequence
  Synthetic Peptide
SNSYDLGSL

SEQ ID NO: 26 - protein, 10 aa, Artificial Sequence
  Synthetic Peptide
SFNSYELPSL

SEQ ID NO: 27 - protein, 10 aa, Artificial Sequence
  Synthetic Peptide
SFNSYEIGSV

SEQ ID NO: 28 - protein, 10 aa, Artificial Sequence
  Synthetic Peptide
SFNSYEVGSI

SEQ ID NO: 29 - protein, 10 aa, Artificial Sequence
  Synthetic Peptide
SFNSYELGSV

SEQ ID NO: 30 - protein, 10 aa, Artificial Sequence
  Synthetic Peptide
SFNSYELGSI

SEQ ID NO: 31 - protein, 10 aa, Artificial Sequence
  Synthetic Peptide
SFNSYEIGSL

SEQ ID NO: 32 - protein, 10 aa, Artificial Sequence
  Synthetic Peptide
SFNSYEVGSL

SEQ ID NO: 33 - protein, 10 aa, Artificial Sequence
  Synthetic Peptide
AFNSYELGSL

SEQ ID NO: 34 - protein, 6 aa, Artificial Sequence
  Synthetic Peptide
YELGSL

SEQ ID NO: 35 - protein, 6 aa, Artificial Sequence
  Synthetic Peptide
YDLGSL

SEQ ID NO: 36 - protein, 6 aa, Artificial Sequence
  Synthetic Peptide
FDLGSL

SEQ ID NO: 37 - protein, 6 aa, Artificial Sequence
  Synthetic Peptide
YDIGSL

SEQ ID NO: 38 - protein, 4 aa, Artificial Sequence
  Synthetic Peptide
IGSL

SEQ ID NO: 39 - protein, 6 aa, Artificial Sequence
  Synthetic Peptide
YDVGSL

SEQ ID NO: 40 - protein, 6 aa, Artificial Sequence
  Synthetic Peptide
YDLPSL

SEQ ID NO: 41 - protein, 6 aa, Artificial Sequence
  Synthetic Peptide
YDLGIL

SEQ ID NO: 42 - protein, 6 aa, Artificial Sequence
  Synthetic Peptide
YDLGSI

SEQ ID NO: 43 - protein, 6 aa, Artificial Sequence
  Synthetic Peptide
YDLGSV

SEQ ID NO: 44 - protein, 4 aa, Artificial Sequence
  Synthetic Peptide
LGSL

SEQ ID NO: 45 - protein, 4 aa, Artificial Sequence
  Synthetic Peptide
IGSL

SEQ ID NO: 46 - protein, 4 aa, Artificial Sequence
  Synthetic Peptide
VGSL

SEQ ID NO: 47 - protein, 4 aa, Artificial Sequence
  Synthetic Peptide
LPSL

SEQ ID NO: 48 - protein, 4 aa, Artificial Sequence
  Synthetic Peptide
LGIL

SEQ ID NO: 49 - protein, 4 aa, Artificial Sequence
  Synthetic Peptide
LGSI

SEQ ID NO: 50 - protein, 4 aa, Artificial Sequence
  Synthetic Peptide
LGSV

SEQ ID NO: 51 - protein, 11 aa, Artificial Sequence
  Synthetic Peptide
ALSTDRGKTLV

SEQ ID NO: 52 - protein, 11 aa, Artificial Sequence
  Synthetic Peptide
ALTSDRGKTLV

SEQ ID NO: 53 - protein, 11 aa, Artificial Sequence
  Synthetic Peptide
ALTTDRGKSLV

SEQ ID NO: 54 - protein, 11 aa, Artificial Sequence
  Synthetic Peptide
ALTTDRPKTLV

SEQ ID NO: 55 - protein, 11 aa, Artificial Sequence
  Synthetic Peptide
ALTTDRGRTLV

SEQ ID NO: 56 - protein, 11 aa, Artificial Sequence
  Synthetic Peptide
ALTTDKGKTLV

SEQ ID NO: 57 - protein, 11 aa, Artificial Sequence
  Synthetic Peptide
ALTTDKGKTLV

SEQ ID NO: 58 - protein, 16 aa, Drosophila sp.
RQIKIWFQNRRMKWKK

SEQ ID NO: 59 - protein, 11 aa, Human immunodeficiency virus 1
YGRKKRRQRRR